(19) United States
(12) Patent Application Publication
(10) Pub. No.: US 2026/0187107 A1
(43) Pub. Date: Jul. 2, 2026

(54) SYSTEMS AND METHODS OF PARALLEL ARTIFICIAL INTELLIGENCE PROCESSING

(71) Applicants: Steven G. Lisa, Paradise Valley, AZ (US); George J. Shen, Centennial, CO (US)

(72) Inventors: Steven G. Lisa, Paradise Valley, AZ (US); George J. Shen, Centennial, CO (US)

(21) Appl. No.: 19/360,623

(22) Filed: Oct. 16, 2025

Related U.S. Application Data
(60) Provisional application No. 63/708,583, filed on Oct. 17, 2024.

(51) Int. Cl. G06F 16/3329; G06F 16/338

(52) U.S. Cl. CPC G06F 16/3329; G06F 16/338

(57) ABSTRACT

The application relates to systems and methods for improving the accuracy and reliability of AI-generated responses to user queries through multi-system orchestration and iterative refinement. A user's query is transmitted to multiple externally maintained, commercially available AI Systems. The responses are compared to identify substantive areas of agreement and disagreement. Based on this analysis, a revised prompt is generated and submitted to the same or different AI Systems, repeating as needed until a final response is produced. The final output may include supporting source information, formatting tailored to highlight consensus and divergence, and provider attribution. The system architecture allows dynamic substitution of AI providers, secure credential management, and output presentation customized for different user needs. Unlike static or single-model systems, the systems and methods enable transparent, adaptive interaction with evolving AI models without requiring internal training or content management.

### CROSS REFERENCE TO RELATED APPLICATIONS

This application claims the benefit of Provisional Application No. 63/708,583, Filed Oct. 17, 2024, which is hereby incorporated by reference in its entirety.

### BACKGROUND

### 1. Field of the Invention

This application relates to the field of Artificial Intelligence (or “AI”) processing of the prompts and queries of a user, and more specifically, systems and methods that take advantage of the many differences among available AI Systems by automatically and iteratively submitting prompts, processing and analyzing responses, reformulating and optimizing subsequent prompts, and formatting final results. The systems and methods provide users with an interface for interacting with common AI Systems, while conducting the iterative, cross-model processing in the background to generate greatly improved final responses validated across multiple AI Systems.

### 2. Description of Related Materials

To reduce the complexity and length of this Specification, and to fully establish the state of the art in certain areas of technology, Applicant(s) herein expressly incorporate(s) by reference certain materials identified in each numbered paragraph below.

AI Systems are now widely used and readily available to the public and accessible via the internet. A few examples of commonly used AI Systems include: (1) ChatGPT by OpenAI; (2) Google Bard; (3) Microsoft's Copilot; (4) Poe by Quora; and (5) Perplexity AI. In addition, there are numerous AI Systems that focus on specific domains, fields and/or purposes, such as, for example: (1) Image Generation; (2) Coding; (3) Data Analysis; (4) Academic Research; (5) Writing; and others. There are established sources that list and track widely used and currently available AI Systems, including for example: (1) “whatpulugin.ai”; (2) GPTsApp.io; (3) AllGPTs Directory, and others. Applicant provides herewith current printouts of those sources, which are expressly incorporated by reference herein. There are also many types of commercially available AI Systems, including (but not limited to): (1) Generative AI; (2) Conversational AI; (3) Language Model AI; (4) Productivity AI; (5) Search and SQ&A AI Systems; (6) GPT-based AI Systems; and others. Some AI Systems, including certain search-based or domain-specific models, incorporate techniques such as retrieval-augmented generation (RAG), in which external documents are retrieved and combined with a prompt before generating a response.

As used herein, the term “AI System” is intended to include all forms of artificial intelligence applications, whether for generating text, engaging in conversation, making decisions, automating tasks, or any other cognitive operations. The inventors intend the term “AI System” to be construed broadly, and includes both AI Systems and AI methods, and hardware and software as applicable, without reliance on distinctions between terms such as “Generative AI,” “Conversational AI,” or “Language Models,” that are not intended to limit the application described herein. The inventors may mention some of the more familiar AI Systems herein, including, for example, Chat GTP. However, the term “AI System” is intended and is used by the inventors as a neutral, high-level term that encompasses all AI technologies and intentionally avoids complexities and technical nuances, and is not in this description or in the claims intended to refer to any one, specific, AI System or type of AI System.

Numerous publicly available manuals, books, articles, and standards introduce and explain various aspects of AI Systems, including programming, design, user interfaces, and known limitations.

The following references provide foundational knowledge regarding AI Systems, including machine learning algorithms, deep learning models, and other known AI architectures, each of which is hereby incorporated herein by reference in its entirety to provide background context and support for the technical field and to provide machine learning algorithms, deep learning models, and other known AI architectures that may be used with the systems and methods described herein:
1. Goodfellow, I., Bengio, Y., & Courville, A. (2016). Deep Learning. MIT Press. ISBN-13: 978-0262035613.
2. Bishop, C. M. (2006). Pattern Recognition and Machine Learning. Springer. ISBN-13: 978-0387310732.
3. Patel, D. M. (2023). Artificial Intelligence & Generative AI for Beginners: The Complete Guide. ISBN-13: 979-8850705527.
4. Mueller, J. P., & Massaron, L. (2021). Artificial Intelligence For Dummies (2nd ed.). For Dummies. ISBN-13: 978-1119796763.
5. Mueller, J. P., & Massaron, L. (2021). Machine Learning For Dummies (2nd ed.). For Dummies. ISBN-13: 978-1119724018.
6. Russell, S., & Norvig, P. (2020). Artificial Intelligence: A Modern Approach (4th ed.). Pearson. ISBN-13: 978-0134610993.

Numerous publicly available manuals, books and articles describe AI programming, including coding practice, use of API's, and popular programming languages such as Python, R, Java, C++, Julia and others. For example, see the following references, each of which is hereby incorporated herein by reference in its entirety to provide technical background about the development and implementation of AI Systems and to provide some of the currently available programming, coding practices, and APIs that may be used with the systems and methods described herein:
1. Cormen, T. H., Leiserson, C. E., Rivest, R. L., & Stein, C. (2009). Introduction to Algorithms (3rd ed.). MIT Press. ISBN-13: 978-0262033848.
2. Géron, A. (2017). Hands-On Machine Learning with Scikit-Learn & TensorFlow. O'Reilly Media. ISBN-13: 978-1491962299.
3. Minnick, C. (2024). Coding with AI For Dummies. For Dummies. ISBN-13: 978-1394249138.
4. Karatas, M. (2024). Developing AI Applications. Rheinwerk Computing. ISBN-13: 978-1493226016.
5. Rodriguez, C. (2024). Generative AI Foundations in Python. Packt Publishing. ISBN-13: 978-1835460825.
6. Grus, J. (2015). Data Science from Scratch. O'Reilly Media. ISBN-13: 978-1491901427.
7. Dedov, F. (2020). The Python Bible 7 in 1. ISBN-13: 979-8629849124.
8. Chambers, B., & Zaharia, M. (2018). Spark: The Definitive Guide. ISBN-13: 978-1491912218.
9. Hunt, A., & Thomas, D. (2019). The Pragmatic Programmer: Your Journey to Mastery (20th Anniversary Edition). Addison-Wesley. ISBN-13: 978-0135957059.

Numerous publicly available manuals, books, articles and technical papers describe AI System architecture, design principles, AI technologies and transformer-based models. For example, see the following publications, each of which is incorporated herein by reference in its entirety to provide AI System architecture, design, and transformer-based technologies that may be used with the systems and methods described herein:
1. Martinez, D. R., & Kifle, B. M. (2024). Artificial Intelligence: A Systems Approach from Architecture Principles to Deployment. MIT Press. ISBN-13: 978-0262048989.
2. Bengesi, S., El-Sayed, H., Sarker, M. K., Houkpati, Y., Irungu, J., & Oladunni, T. (2024). Advancements in Generative AI: A Comprehensive Review of GANs, GPT, Autoencoders, Diffusion Model, and Transformers. IEEE Access, 12, 69812-69837. DOI: 10.1109/ACCESS.2024.3397775.
3. Yenduri, G., et al. (2024). GPT (Generative Pre-Trained Transformer)—A Comprehensive Review on Enabling Technologies, Potential Applications, Emerging Challenges, and Future Directions. IEEE Access, 12, 54608-54649. DOI: 10.1109/ACCESS.2024.3389497.
4. Tune, N., & Perrin, J. G. (2024). Architecture Modernization: Socio-technical Alignment of Software, Strategy, and Structure. ISBN-13: 978-1633438156.
5. Richards, M., & Ford, N. (2020). Fundamentals of Software Architecture: An Engineering Approach. O'Reilly Media. ISBN-13: 978-1492043454.
6. Gamma, E., Helm, R., Johnson, R., & Vlissides, J. (1994). Design Patterns: Elements of Reusable Object-Oriented Software. Addison-Wesley. ISBN-13: 978-0201633610.
7. Vaswani, A., Shazeer, N., Parmar, N., Uszkoreit, J., Jones, L., Gomez, A. N., Kaiser, L., & Polosukhin, I. (2017). Attention Is All You Need. Advances in Neural Information Processing Systems.
8. Devlin, J., Chang, M. W., Lee, K., & Toutanova, K. (2018). BERT: Pre-training of Deep Bidirectional Transformers for Language Understanding. Proceedings of the NAACL-HLT.
9. Verena, P. C. (2023). The Ultimate Guide to ChatGPT. ISBN-13: 979-8391354833.
10. Grant, R. (2023). Prompt Engineering and ChatGPT. Pebblefalls Press. ISBN-13: 978-1962079068.
12. Baker, P. (2023). ChatGPT For Dummies (1st ed.). For Dummies. ISBN-13: 978-1394204632.
13. Richardson, C. (2018). Microservices Patterns: With Examples in Java. Manning Publications. ISBN-13: 978-1617294549.
14. Kleppmann, M. (2017). Designing Data-Intensive Applications. O'Reilly Media. ISBN-13: 978-1449373320.
15. Tune, N., & Perrin, J. G. (2024). Architecture Modernization: Socio-technical Alignment of Software, Strategy, and Structure. ISBN-13: 978-1633438156.
16. Richards, M., & Ford, N. (2020). Fundamentals of Software Architecture: An Engineering Approach. O'Reilly Media. ISBN-13: 978-1492043454.
17. Berkeley Artificial Intelligence Research. “The Shift from Models to Compound AI Systems.” The Berkeley Artificial Intelligence Research Blog, Feb. 18, 2024.
18. “Multimodal: AI's New Frontier.” MIT Technology Review, May 8, 2024.
19. Databricks. “Generalists vs. Specialists: Evolution of AI Systems Toward Compound AI.” Databricks Blog, Oct. 1, 2024.

It is known that different AI Systems may generate different responses to an identical user prompt or query. These differences may be caused by a variety of factors, including (among other things): (1) the probabilistic generation and ranking of responses by each AI System, (2) differences in training data and embedded biases (whether intentional or inadvertent), (3) variations in algorithmic architecture between AI Systems (e.g., deep neural networks, decision trees, and other approaches), (4) different priorities or optimization goals between AI Systems (e.g., accuracy vs. speed vs. efficiency); (5) the use of stochastic processes or randomness (i.e., non-determinism); and (6) prior interactions with a current user or other users, that can cause even the same AI System to return different responses to the same prompt under similar conditions. For additional discussion, see the following references each of which is incorporated herein by reference in its entirety to provide discussions of these phenomena:
1 Output from AI LLMs is Non-Deterministic. What that means and why you should care.—Sitation,
2. Why ChatGPT And Other LLMs Generate Different Answers to Same Questions;
3. Why ChatGPT and Other LLMs Generate Different Answers to Same Questions;
4. Pereira, A., Brito, P. Q., & Marra, D. G. (2023). Probabilistic Generation and Ranking in Language Models: Analyzing Response Divergence. Journal of Artificial Intelligence Research, 68(2), 65-85. DOI: 10.1613/jair.12358.
5. Jelinek, F., & Mercer, R. L. (2020). Training Data and Bias in Neural Language Models. IEEE Transactions on Neural Networks, 31(4), 499-512. DOI: 10.1109/TNN.2020.2972469.
6. Vaswani, A., Shazeer, N., Parmar, N., Uszkoreit, J., Jones, L., & Gomez, A. N. (2017). Attention Is All You Need. Advances in Neural Information Processing Systems, 30, 5998-6008.
7. Bengio, Y., Courville, A., & Vincent, P. (2013). Algorithmic Differences in AI: A Comparative Study of Generative Models. IEEE Transactions on Neural Networks and Learning Systems, 24(4), 599-615. DOI: 10.1109/TNNLS.2013.2242067.
8. Mnih, V., Kavukcuoglu, K., Silver, D., Rusu, A. A., & Veness, J. (2015). Prioritization in AI Systems: Balancing Speed and Accuracy. Nature, 518(7540), 529-533. DOI: 10.1038/nature14236.
9. Devlin, J., Chang, M. W., Lee, K., & Toutanova, K. (2018). BERT: Pre-training of Deep Bidirectional Transformers for Language Understanding. Proceedings of the NAACL-HLT.
10. Li, S., Zeng, Z., & Yang, L. (2022). Stochasticity and Non-Determinism in AI: The Role of Randomness in Large Language Models. IEEE Access, 10, 87352-87363. DOI: 10.1109/ACCESS.2022.3207123.
11. Chanda, S. S., Banerjee, D. N. Omission and commission errors underlying AI failures. AI & Soc 39, 937-960 (2024).

A class of artificial intelligence (AI) systems known as “Retrieval-Augmented Generation” (RAG) has recently been proposed to improve the factual grounding and topical relevance of AI-generated outputs. In general, RAG systems operate by retrieving external documents from a local or remote corpus based on a user's query, and then presenting the retrieved content to a large language model (LLM) as part of the input context or prompt, from which a final response is generated. These systems are designed to supplement the LLM's internal knowledge with more current or domain-specific information. See, e.g., Lewis et al., “Retrieval-Augmented Generation for Knowledge-Intensive NLP Tasks,” arXiv:2005.11401 (2020); and Chen et al., “Open-Domain Question Answering,” arXiv:1704.00051 (2017), each of which is incorporated herein by reference in its entirety for RAG techniques. Retrieval-augmented generation has also been described in published patent applications, including U.S. Patent Application Publication No. 2024/0346256 A1 (“Response Generation Using a Retrieval Augmented AI Model”) and U.S. Patent Application Publication No. 2024/0311407 A1 (“Artificial Intelligence Agricultural Advisor Chatbot”). Each of these publications is hereby incorporated herein by reference in its entirety to provide RAG system implementations that may be used with the systems and methods described herein.

While RAG systems offer certain advantages—such as improved factual grounding and the ability to retrieve content from dynamic or specialized corpora—they exhibit several important limitations. These systems are highly dependent on the quality, scope, and structure of the underlying retrieval corpus, which may omit key information or introduce outdated or irrelevant content. More significantly, RAG systems typically rely on a single large language model (LLM) to synthesize retrieved material, meaning the final output remains subject to that model's inherent biases, limitations, and susceptibility to hallucination. In addition, RAG architectures are generally designed to retrieve static documents rather than to dynamically query or interact with live AI Systems. As such, they lack the capability to orchestrate or manage concurrent interactions with multiple commercially available AI services—each of which may generate divergent outputs in response to the same prompt. Traditional RAG-based frameworks do not support systematic comparison of responses from distinct AI models, nor do they implement structured mechanisms for evaluating divergence, generating follow-up prompts, or consolidating results across independently operating systems.

In addition to single-model RAG systems, recent academic work has explored multi-agent AI Systems where different large language models (LLMs) or agents work together to solve problems. For example, Zeng et al., A Survey on LLM-Based Multi-Agent Systems: Workflow, Infrastructure, and Challenges, Springer (October 2024), which is hereby incorporated by reference in its entirety, describes various ways agents can be designed to talk to each other or share tasks, mostly in research or lab settings. Wu et al., Your Co-Workers Matter: Evaluating Collaborative Capabilities of Language Models in Blocks World, ACL Findings (August 2024), which is hereby incorporated by reference in its entirety, shows how multiple agents can cooperate in a simple “Blocks World” simulation, by following set rules and using one main LLM. While these systems may work for limited tasks in controlled environments, they are not designed to work with real-world, commercial AI Systems. Multi-agent AI Systems typically do not allow for comparing different answers from multiple providers, can't handle conflicting results, and don't adapt as outside systems improve. In short, they don't solve the practical problems that the systems and methods described herein are designed to address.

Accordingly, there remains a significant need for systems and methods that overcome the limitations of existing AI architectures, including RAG systems, single-model solutions, and multi-agent academic frameworks. Prior approaches fail to support meaningful comparison across different models, lack structured ways to measure consensus or disagreement, and do not adapt prompts when conflicting outputs appear. They also depend on static document corpora or fixed workflows, making them poorly suited for handling ambiguity, gaps in coverage, or the fast-paced evolution of AI services.

The systems and methods described herein address these and other shortcomings by submitting a user's query to multiple, independently managed AI Systems in serial, parallel, or combinations thereof. They automatically compare the responses, identify areas of agreement and disagreement, and use that analysis to drive targeted, iterative follow-up prompts to the same or even different AI Systems. The result is a consolidated output that reflects refined, high-confidence information—drawn from diverse AI sources that may initially provide inconsistent or conflicting answers, but which are iteratively improved through automated prompting. All of this processing occurs in the background, giving users a simple interface and consistent experience. The systems and methods also remain fully compatible with improvements in underlying AI models—automatically taking advantage of their evolving capabilities without requiring internal changes. In some applications, users may customize behavior, such as prioritizing certain providers or weighting different response traits (e.g., speed, accuracy, creativity). This flexible, real-time framework ensures that users benefit from the best available AI technologies while receiving results that are accurate, transparent, and easy to understand.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the pertinent portions of the essential material that is incorporated by reference as allowed by the applicable rules.

### SUMMARY

Aspects and applications presented here are described below in the drawings and detailed description.

Regarding the meaning of terms used herein, unless specifically noted, it is intended that the words and phrases in the specification and the claims be given their plain, ordinary, and customary meaning to those of ordinary skill in the applicable arts. The inventor is fully aware that a patent applicant may serve as their own lexicographer if desired. Here, the inventor expressly elects to use only the plain and ordinary meaning of terms in the specification and claims unless the inventor (i) clearly states otherwise, and (ii) also expressly states and sets forth the “special” definition of that term and explains how it differs from the plain and ordinary meaning. Absent such a clear statement of intent to apply a “special” definition to a term, it is the inventor's intent and desire that all terms be interpreted according to their simple, plain and ordinary meaning in both the specification and claims.

Thus, for example, to avoid confusion, the inventor has clarified above that—although GPT-based AI Systems are frequently used as examples—the term “AI System” is intended to carry a broad, generic meaning that avoids technical jargon and remains inclusive and flexible across all types of AI Systems. Likewise, the phrase “GPT Management Server” as used herein is not intended to be limited to a single or even a physical server. Rather, the phrase “GPT Management Server” is intended to include and could be implemented in many forms of servers, including without limitation, a cloud solution, infrastructure as a service, a single server, a parallel processor, multiple distinct servers, and other well-known alternatives.

The inventor is also aware of the normal rules of English grammar. Accordingly, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the clear use of such adjectives, descriptive terms, or modifiers, it is the intent that such nouns, terms, or phrases be given their plain, and ordinary English meaning as understood by those skilled in the applicable arts, as set forth above.

Further, the inventor is fully informed of the standards and application of the special provisions of 35 U.S.C. § 112(f). Accordingly, the use of the words “function,” “means,” or “step” in the Detailed Description or Description of the Drawings or claims is not intended to indicate a desire to invoke the special provisions of 35 U.S.C. § 112(f) to define the inventions. To the contrary, if the inventor intends to invoke the provisions of 35 U.S.C. § 112(f) to define the inventions, the claims will specifically and expressly state the exact phrases “means for” or “step for,” and will also expressly include and recite the specific word “function” (i.e., will state “means for performing the function of [insert function]”), and will intentionally also not recite any structure, material or act in support of the function. Thus, even when the claims recite a “means for performing the function of . . . ” or “step for performing the function of . . . ,” if the claims also recite structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the claimed inventions not be limited only to the specific structure, material or acts that are described in the preferred embodiments, but also encompass but also encompass any and all structures, materials, or acts that perform the claimed function, whether described in alternative embodiments, or known equivalents, whether now existing or later developed.

The aspects, features, and advantages will be apparent to those of ordinary skill in the art from the DETAILED DESCRIPTION, DRAWINGS, and CLAIMS. However, without attempting to characterize or limit the scope of inventions as described and claimed, some of the advantages of the various inventions are summarized below.

As noted in the “Introduction” section of the Chanda and Banerjee article (cited above):
“Instances of AI Systems failing to deliver consistent, satisfactory performance are legion . . . AI Systems can fail (a) if there are problems with its inputs comprising various representations of data, sensor hardware, etc. and/or (b) if the processing logic is deficient in some way and/or (c) if the repertoire of actions available to the AI System is inadequate, i.e. if the output is inappropriate. Further, these problems/deficiencies/inadequacies originate from two kinds of errors—commission and omission errors—in the design, development and deployment of an AI System.”
   (See: Chanda, S. S., & Banerjee, D. N. (2024). Omission and commission errors underlying AI failures. AI & Society, 39, 937-960.

It is an object to provide AI Systems and methods that generate improved results in responses to user prompts or queries.

It is an object to provide improved AI Systems and methods configured to generate improved AI responses by leveraging what is often viewed as a flaw—the differences among AI Systems (e.g., unique training data, processing logic, etc.), which frequently result in different or inconsistent answers to the same user prompt or query. Among other advantages, the systems and methods turn unwanted disagreement among distinct AI Systems into a strength by comparing answers across those systems and using those differences to guide targeted follow-up prompts that yield a more reliable final result.

It is an object to provide systems and methods that are configured to take advantage of the differences among various AI Systems by iteratively processing and evaluating their responses, revising, improving and refining the user query, and ultimately generating an accurate and improved result. Among other advantages, this iterative refinement directly addresses limitations of prior AI Systems, ensuring that ambiguity or conflict leads to progressively better answers instead of unresolved inconsistencies.

It is an object to provide systems and methods configured to generate enhanced AI responses by processing prompts or queries through multiple AI Systems and evaluating the outputs to identify areas of agreement and divergence among the responses. Among other advantages, the systems and methods overcome the limitation of single-model approaches, which cannot detect conflicts or measure consensus across multiple independent systems.

It is an object to provide systems and methods that are configured to improve the content, quality, and reliability of the results received in response to a user prompt or query to AI Systems. The systems and methods automatically and iteratively submit the user's prompt (in parallel, series, or in other appropriate manners) to multiple distinct AI Systems and then compare, analyze and evaluate the responses to identify areas of agreement and disagreement. This comparative analysis enables the generation of revised follow-up prompts and consolidated responses that better reflect the strengths and nuances of the participating AI Systems. Among other advantages, by integrating multiple independent providers in this way, the systems and methods avoid dependence on static data sets and single-model approaches.

It is an object to take advantage of the fact that no two AI Systems are the same by submitting prompts or queries to several distinct AI Systems, and vetting the independent results through iterative prompts that refine and focus the inquiry—causing each distinct system to reconsider not only its initial response, but also the similar and/or different response of the other contemporaneously prompted AI Systems. Among other advantages, this approach transforms variability into a structured tool for improvement, ensuring that disagreement drives refinement rather than leaving users with conflicting or incomplete answers.

It is an object to provide systems and methods that conduct iterative processing of a user-generating AI Prompt in the background, and generate an improved consolidated responses for the user—without requiring the user to gain additional training or technical knowledge in order to obtain vastly improved AI results to an original AI query. Among other advantages, this background orchestration automates multi-system querying and refinement, eliminating the need for user intervention and surpassing static, single-model methods.

It is an object to provide systems and methods that generate improved responses to a user's AI query by leveraging the uniqueness, differences and continual improvements in and among commercially available AI Systems without requiring any internal modification, customization, or integration with those different AI Systems or providers. Instead, the systems and methods manage the iterative formatting and submission of a user's AI query to then-existing conventional AI Systems, evaluate the responses to identify areas of consensus and conflict, and then iteratively create and resubmit a new AI query to the same or other conventional AI Systems for further analysis to provide the user an improved, more comprehensive and more reliable response. The iterative refinement process with multiple commercially available and distinct AI Systems provides greatly improved results. Among other advantages, this approach ensures broad compatibility with current and existing AI Systems and improves upon research frameworks that depend on custom or hardcoded multi-agent roles.

It is an object to provide systems and methods that are configured to test, re-test, re-evaluate, and consolidate areas of commonality and difference in prior responses to the same input query submitted to multiple AI Systems. The systems and methods generate at least one revised follow-up query (or prompt) that is re-submitted to one or more of the AI Systems (in parallel, in series, or otherwise) for further refined analysis. In this manner, each AI System can reconsider and re-evaluate its prior answers in light of a newly improved query that focused on the areas of or agreement or disagreement of the prior responses. Among other advantages, this iterative cycle addresses the shortcomings of static, single-pass methods by using disagreement among systems to drive continued refinement and improvement.

It is an object to provide systems and methods that are configured to launch a GPT Management Server that is operable to select (either automatically or by user input) a set of commercially available AI Systems to process user-generated prompts or queries. Among other advantages, this server layer enables scalable management of diverse and continually improving AI providers, overcoming the limitations of prior systems that rely on a single model or static retrieval source.

It is an object to provide systems and methods that are configured to allow a user to easily select preferred AI Systems—chosen from among the many commercially available and continually improving AI providers—to which the user's prompts or queries are submitted, thereby enabling the user to interact through a familiar and simplified interface without needing to manage the underlying system differences. Among other advantages, this user-facing flexibility contrasts with academic multi-agent frameworks, which are typically hardcoded for specific models and lack adaptability to evolving commercial services.

It is an object to provide systems and methods that evaluate a user-created AI Prompt and automatically select a set of commercially available current AI Systems, each of which iteratively processes the user's prompt and considers the responses of the other AI Systems and then generates and presents to the user a consolidated response. Among other advantages, this automated selection inherently takes advantage of constantly improving and evolving commercially available AI Systems, and addresses a gap in legacy AI Systems, which neither coordinate multiple providers nor reconcile their differing and uniquely improving outputs into a unified result.

It is an object to provide systems and methods that seamlessly present to a user a display interface enabling selection of multiple distinct and commercially available AI Systems to which the user is subscribed to direct prompts or queries. The systems and methods then evaluate the individual responses from the selected AI Systems and either generate a revised follow-up prompt to resubmit the AI Systems or, alternatively, share the responses of each system with the others in the set for further consideration. This process continues iteratively until an improved consolidated response is generated for the user. Among other advantages, by operating through the user's existing subscriptions, the system delivers enhanced results in a cost-effective manner and avoids rigid, hardcoded agent assignments.

It is an object to provide systems and methods that present a user's single AI prompt or query to multiple user-selected commercially available AI Systems, while securely transferring or communicating the user's login, password and security/authentication data so that the selected AI Systems do not detect or determine that an identical query is being automatically submitted contemporaneously (in parallel, serial or a combination thereof) to multiple AI Systems or providers. Among other advantages, this secure handling of credentials ensures compatibility with already-subscribed commercial providers while protecting user privacy.

It is an object to provide systems and methods with a user interface that updates the user in real time with the results of a query or prompt being submitted and processed contemporaneously (in parallel, series or combination thereof) through multiple iterations. The interface may include dynamically updated outputs (e.g., tables with updating answers) and progress indicators (e.g., a progress bar) that reflects the ongoing analysis and processing. Among other advantages, this real-time visibility gives users clarity and confidence in the process, unlike prior systems that act as “black boxes” and reveal only a static final answer.

It is an object to provide systems and methods wherein the improved results from querying or prompting multiple AI Systems include a consolidated listing of authoritative sources (including clickable links to websites, articles or references) identified or consulted by each AI System and that most closely support the individual statements in the consolidated response. Among other advantages, a focus on transparent, real-time feedback improves upon prior systems that provide only static final outputs and give the user no visibility into how results evolve or improve through iteration.

It is an object to provide systems and methods that automatically take advantage of improvements, upgrades, and enhancements made by third-party AI providers without requiring any modification or customization of the inventive system. The systems and methods are designed to remain fully compatible with continuously advancing AI services, thereby maximizing their performance as AI models evolve. Among other advantages, this transparent and ongoing adaptability overcomes limitations of prior architectures that are locked to specific models or data and cannot seamlessly incorporate ongoing advances.

It is an object to provide systems and methods that are configured to analyze conflicting or divergent responses from multiple AI Systems and use those differences to generate targeted follow-up prompts. These follow-up prompts are designed to clarify, test, or probe the areas of disagreement in order to refine and improve the overall response. Among other advantages, this approach turns conflict into a constructive driver of refinement, addressing a major gap in systems that lack mechanisms for systematically resolving disagreements between models.

It is an object to provide systems and methods that conduct parallel, serial, or combined analyses without requiring any of the AI Systems to be assigned a fixed or predetermined role, and that instead allow the AI Systems to be selected and utilized interchangeably in responding to the user's prompts and revised prompts, thereby avoiding the limitations of prior approaches that depend on rigid, role-based multi-agent configurations.

It is an object to provide systems and methods that generate improved AI responses without retrieving information from static document corpora. Instead of relying on preloaded or indexed data, the systems can be configured to interact directly with live, commercially available AI services in real time to produce consolidated and current answers. Among other advantages, these improvements overcome the central limitation of systems that depend on fixed data that may be incomplete, outdated, or irrelevant.

It is an object to provide systems and methods that are not dependent on pre-assigned roles or fixed operations for different AI agents. Rather, the systems can be configured to treat each queried AI System as an independent and interchangeable source of output, which can be compared, tested, and refined dynamically without relying on predefined workflows. Among other advantages, this flexibility avoids the rigidity of prior multi-agent frameworks, with hardcode agent roles and cannot adapt seamlessly to diverse or evolving commercial AI services.

It is an object to provide systems and methods in which the full process of orchestration, querying, output comparison, and follow-up prompt generation is handled automatically in the background. This allows users to receive improved responses with minimal input, without needing to understand or manage the multiple AI Systems involved. Because the system can externally employ multiple, user-selected, commercially available AI Systems in the background—without modifying AI System provider internals—and expressly allow substitution/addition of providers during iterative cycles, improvements introduced by those providers are inherently and transparently realized by the systems and methods without any modification to the system itself. Among other advantages, this seamless background orchestration distinguishes systems that burden the user with managing complex workflows or rely on static, single-pass pipelines.

It is an object to provide systems and methods that leverage existing commercial AI services without requiring any internal access, modification, or customization of those services. The systems can operate externally, using standard APIs or interfaces, and work with off-the-shelf AI providers without compromising operations or requiring proprietary integration. Among other advantages, this non-invasive design ensures broad compatibility with current and future providers, unlike systems and methods that depend on customized or proprietary integrations.

The above and other objects are achieved by various systems and methods described herein, including but not limited to systems and methods that automatically process a user's AI prompt or query by (1) receiving a prompt at a server and presenting that prompt to multiple distinct AI Systems, (2) receiving at the server and then comparing and analyzing the responses from each distinct AI System to identify areas of commonality and difference in the initial responses, (3) reformulating and re-submitting from the server to the distinct AI Systems a revised and improved prompt or query; (4) causing the AI Systems to reconsider the areas of commonality and difference by further analysis of the improved prompt or query, (5) if desired, repeating, by the server, the comparing, analyzing, reformulating and re-submitting of prompts until a stopping condition is satisfied, the stopping condition including any or all of (i) reaching a level of agreement among the responses, (ii) detecting a point of diminishing returns, or (iii) exceeding a predetermined cycle limit, and (6) organizing and visually presenting to the user through the server, a consolidated response showing the specific areas of commonality and differences to the initial user prompt.

The above and other objects are achieved by various systems and methods described herein, including but not limited to systems and methods that are configured to enable a user to designate the AI Systems that are to be used in the parallel, serial or combined analyses of a prompt, as if the user is submitting it to a single AI System. The systems and methods can be configured to allow the multiple iterations of queries and responses to be conducted “in the background” by the server so that the user has the same experience as if submitting a single prompt and getting a single answer. Once the user has authorized the server to access the selected AI Systems, such authorization being handled in accordance with known credential-delegation practices, the background orchestration can proceed without requiring the user to repeatedly supply login credentials or complete authentication challenges. The systems and methods can further be configured to organize the consolidated result so that it includes citations or references from the plurality of AI Systems supporting the identified areas of agreement and disagreement, thereby allowing the user to verify or further explore the information presented.

The above and other objects are achieved by various systems and methods described herein, including but not limited to systems and methods that conduct the parallel, serial, or combined analyses without assigning fixed or predetermined roles to the plurality of AI Systems, and that dynamically select which AI Systems to use at each iteration based at least in part on characteristics of the user's prompt, the type of information requested, or the observed performance of the AI Systems in prior iterations. The systems and methods also can allow substitution of one or more AI Systems or the addition of new AI Systems in subsequent iterations, so that the set of providers can change over time while the server continues to manage the orchestration in the background. This configuration provides the advantage of increased flexibility in selecting and substituting AI Systems, improves reliability by avoiding dependence on any single provider, and allows the system to adapt dynamically to the strengths of different AI Systems as they evolve.

The above and other objects are achieved by various systems and methods described herein, including but not limited to systems and methods that are configured to continue to resubmit the areas of commonality and difference to each distinct AI System for further analysis until a set of results exists with satisfactory areas of agreement or a statistical point of diminishing returns is reached. The systems and methods can also be configured to allow the user to select how many times the areas of commonality and difference are resubmitted to each distinct AI System for further analysis. The systems and methods can also be configured to tabulate and present to the user a consolidated result, answer or response that identifies the areas of commonality and areas of difference based on the combined and iterative responses of the distinct AI Systems. By directing the iterative resubmissions to specifically address areas of disagreement, the systems and methods ensure that conflicts among initial responses drive constructive refinement rather than being left unresolved.

The above and other objects are achieved by various systems and methods described herein, including but not limited to systems and methods that remain compatible with improvements, upgrades, or enhancements made by third-party AI Providers. The systems and methods can treat each AI System as an independent external service and manages the formatting, submission, and analysis of prompts at the server level without modifying or customizing the underlying providers, thereby capturing any upgrades or new capabilities introduced by those AI Providers which are in turn automatically incorporated into the results generated by the system. In some implementations the systems and methods may resubmit prompts to the same or a new or different set of AI Systems, including specialized providers, with the iterative processing carried out in the background so that the user experiences interaction as if with a single system. As a result, when an underlying AI System is improved or replaced with a newer version, the systems and methods transparently benefit from the upgraded capabilities without requiring internal redesign or retraining, thereby providing a forward-compatible framework that overcomes the limitations of prior approaches tied to fixed data sources or fixed models.

The above and other objects are achieved by various systems and methods described herein, including but not limited to systems and methods that continue the iterative resubmission and analysis of prompts and responses until a stopping condition is satisfied, the stopping condition including at least one of: a determination that the responses from the plurality of AI Systems exhibit a sufficient level of agreement, a determination that additional iterations are unlikely to produce further meaningful changes in the responses, or a maximum number of iterations specified by the user. This configuration provides the advantage of ensuring that the iterative process converges efficiently, avoids unnecessary repetitions once further progress would yield little added value, and delivers a consolidated result that balances accuracy, completeness, and processing efficiency.

The above and other objects are achieved in various systems and methods described herein, including but not limited to systems and methods that are configured to improve the output of AI Systems by: (1) formulating a First AI Query that is submitted to multiple selected AI Systems, the selection including AI Systems designated by the user and, if desired, additional AI Systems identified by the server; (2) evaluating a set of First AI Responses to the First AI Query received from each of the AI Systems; (3) generating a First Consolidated AI Response that identifies, organizes, and ranks the areas of agreement/consistency and disagreement/differences in the set of First AI Responses; (4) using, at least in part, the Consolidated First AI Response to generate a Second AI Query that is submitted to each of the selected AI Systems and that requests each to reconsider, probe, and re-evaluate their respective First AI Response in view of the new information presented in the Second AI Query; (5) evaluating a set of Second AI Responses to the Second AI Query received from each of the AI Systems; (6) generating a Second Consolidated AI Response that identifies, organizes, and ranks the areas of agreement/consistency and disagreement/differences in the Second AI Responses; (7) repeating the above operations, if needed, until the areas of agreement/consistency and disagreement/differences reach a statistically significant level to represent an acceptable Final Consolidated AI response; and (8) presenting the Final Consolidated AI Response to the user in a manner that identifies, explains and ranks the areas of agreement and disagreement, and if requested by the user, providing citation to relevant authority best supporting the results. This iterative process provides the advantage of resolving conflicts among differing AI outputs, adapting dynamically to the strengths of the selected AI Systems, and delivering a reliable consolidated response without requiring the system to modify or retrain the underlying AI Systems.

The above and other objects are achieved in various systems and methods described herein, including but not limited to systems and methods that minimize errors in AI responses by, after completing a first round of prompts and answers from multiple user-selected AI Systems, evaluating the responses to obtain a first consolidated response that identifies areas of agreement and disagreement. The first consolidated response can be used to formulate a second query that is resubmitted to the same or a different set of AI Systems to further analyze and refine the areas of commonality, concurrence, agreement, difference, or disagreement through another round of serial or parallel prompting. If desired, new and/or distinct (and, if desired, specialized) AI Systems can be included in the subsequent rounds to expand analysis or provide targeted expertise. The new or additional AI Systems used for analysis can be selected by the user or the AI Systems conducting the initial rounds of analysis. This iterative refinement improves the accuracy and reliability of the final consolidated result while allowing the system to adapt dynamically to the strengths of the available AI Systems.

### BRIEF DESCRIPTION OF THE DRAWINGS

A more complete understanding may be derived from the following description taken in conjunction with the accompanying illustrative figures, which depict examples of program flows and system structures. The figures are provided for purposes of explanation and illustration, and are not intended to limit the scope of any inventions.

FIG. 1 is an example program flowchart showing operations carried out by systems and methods that are configured to iteratively process an initial user prompt through multiple different AI Systems, including receiving the prompt at a GPT Management Server (10), enabling user selection of subscribed AI System providers (12), selecting a processing mode (14), revising prompts as needed (16), submitting to selected GPT Providers (18), evaluating initial responses (20-22), generating improved prompts (24, 28), re-submitting them for further analysis (30, 32), determining a final result (34), and presenting a comprehensive consolidated response to the user (36).

FIG. 2 is an example program flowchart showing systems and methods that are configured to present to the user a consolidated output generated by the GPT Management Server (38), including user selection of output format and detail (40-44), formatting and organization of consensus and contention responses (46), and final presentation to the user (46).

FIG. 3 is an example block diagram showing systems and methods that are configured to conduct advanced processing of AI queries in parallel, serial, sequential or combinations thereof including a user device (50), application interfaces for prompt input and output (52, 54), a management server (56), and multiple GPT targets (58, 60, 62).

FIG. 4 is an example block diagram showing systems and methods that are configured to conduct parallel, serial sequential (or combinations thereof) processing of AI queries, including a user device (64), a GPT management server (66), prompt receiver (68), master GPT engine (70), status updater (72), selection and verification components (74, 76), prompt preparation and iteration (78), thread management (80), response correlation (82), consensus and contention storage (84), contention resolution (86), and updated status reporting (88).

FIG. 5 is an example block diagram showing systems and methods that are configured to provide advanced management of AI queries, including user input (90), a GPT management server (92), a user prompt queue (94), availability and selection of GPT providers (96, 98), account verification (100), parallelization process (102), prompt and source management (104), user update and interrupt handling (106), consensus and contention evaluation (108), storage of GPT prompt/response history (110, 112, 114), correlation of responses (116), contention prompt generation (118), storage of consensus and supporting sources (120), GPT engines interfacing with third-party systems (122, 124, 126), external GPT providers (128, 130, 132), and a user interface displaying results (134).

Elements, structures, and operations in the Figures are illustrated for clarity and simplicity, and are not necessarily shown to scale or in a required sequence. The Figures are intended to illustrate structural and operational aspects of the disclosed systems and methods and should not be interpreted as limiting the scope of any inventions.

### DETAILED DESCRIPTION

In the following description, and for purposes of explanation, numerous specific details are set forth to provide a thorough understanding of various aspects of the disclosed systems and methods. It will be understood, however, by those skilled in the relevant arts, that the systems and methods may be practiced without all these specific details. In other instances, known structures, devices and operations are shown or discussed more generally to avoid obscuring the inventions. In many cases, a description of the operation is sufficient to enable one skilled in the arts to implement the various forms of the systems and methods, particularly when implemented in software. It should be noted that there are many different and alternative configurations, devices and technologies to which the disclosed systems and methods may be applied. The full scope of the disclosed systems and methods is not limited to the examples that are described below.

AI Systems (such as generative systems, transformer-based models like GPT, retrieval-augmented generation (RAG) systems, or other large language models) typically operate using vast knowledge bases compiled from many diverse sources. These knowledge bases, as well as the programming of each AI System, evolve over time. To generate responses to user prompts or queries, each AI System synthesizes information from its current database, typically based on a form of “consensus” that reflects an averaged perspective of the ideas and facts present in its training data. This consensus is not a definitive truth, but more typically, a statistical aggregation derived from the frequency, context, and patterns of information within the data. As a result, each AI System produces outputs that align with prevailing views in its own training set—effectively embodying a designer-determined perspective of current collective knowledge.

However, these characteristics also expose critical limitations. A user relying on only one or two AI Systems will receive responses shaped by those systems' respective configurations and inherent biases, which may lead to incomplete, slanted, or incorrect information. Existing solutions do not provide transparency into how responses are generated, offer no structured mechanism for comparing outputs across different AI System providers, and do not support dynamic selection or orchestration of multiple AI Systems. Users cannot readily adapt to newer or more accurate models as they become available, nor can they easily leverage the diversity of insights across systems. Moreover, conventional implementations offer little support for secure credential handling, background execution, or seamless integration with evolving AI technologies.

As described below, the disclosed systems and methods do not merely address these existing shortcomings, they take advantage of them by enabling coordinated, user-driven orchestration of iterative querying of multiple commercially available AI Systems. The systems and methods do so without requiring internal modification of any AI System provider's model. By leveraging the fact that different AI Systems are trained on distinct datasets or with different methodologies, the disclosed systems and methods actually embrace and capitalize on the variation in respective “consensus” responses from different AI Systems. Each unique AI System processes information according to its specific training data and algorithms, and by comparing outputs from multiple AI Systems, the present systems and methods provide users with a more refined, definitive, broader and nuanced understanding of a given topic. This approach reduces over-reliance on any single source, enhances reliability through diversity, and ensures continued compatibility with AI Systems as they evolve.

More specifically, the disclosed systems and methods are grounded on submitting a prompt to multiple commercially available AI Systems, and analyzing their respective responses, including their unique and often at least partially inconsistent views. As a result, the system and methods can systematically determine several key factors.

Among these factors, the systems and methods are configured to identify areas of “consensus” across the different outputs from the AI Systems, revealing what is commonly agreed upon and reflecting a shared understanding or accepted knowledge that beneficially results from distinctly different databases, hardware systems, programming, and bias. The systems and methods can also pinpoint the “contested” issues—those areas where the outputs of the AI Systems diverge—thus highlighting differences in interpretation, emphasis, bias, focus, programming, hardware or perspective. In this way, the systems and methods identify not only where consensus exists, but also the areas of divergence. These divergences may result from different causes, including the inherent complexity or ambiguity of certain subject matter, as well as from the technical and operational differences between the individual AI Systems. However, rather than treating such divergence as a flaw, the disclosed systems and methods use both consensus and divergence to derive a more comprehensive and balanced understanding of the subject matter addressed in the user's original query.

In addition, the systems and methods are configured to convert the identified areas of consensus and divergence into improved queries or prompts for resubmission to the same or to newly selected AI Systems for further processing. In some configurations, each response from an AI System may be resubmitted to one or more of the other AI Systems for further consideration. This allows each AI System to evaluate the same revised, improved and focused prompt in light of the responses generated by others. Alternatively, the server may consolidate and process the returned responses to identify consensus and divergence, and automatically generate an improved, consolidated query that is then resubmitted to one or more AI Systems. In either case, each AI System (and, optionally, additional newly selected AI Systems) is instructed to reconsider its prior response in view of what has been learned from the others. This orchestrated iterative process continues until a statistically significant convergence or unified response is achieved from the multiple AI Systems. That response is then formatted and presented to the user.

In this manner, the user engages with a familiar process. The user submits a query as they normally would and receives a significantly enhanced answer—formatted in a familiar way—but generated through a robust, background process. In the background, the inventive systems and methods automatically and iteratively refine and resubmit the user's prompt to multiple AI Systems until a consolidated, high-confidence response is derived. If desired, a visual progress indicator or user interface element may be displayed to reflect the background processing, and the final output may optionally include source references, contributor attribution, response formatting and confidence level options as further described below.

The disclosed systems and methods are configured so that, at the start of a session, the user authorizes the server to access one or more AI Systems to which the user is subscribed. This authorization may be implemented using standard credential-delegation protocols (e.g., OAuth 2.0 or OpenID Connect), allowing the user to grant the server a scoped access token rather than exposing passwords or long-lived credentials. In some configurations, the user may be prompted to provide authentication credentials or respond to a CAPTCHA during session initiation. Once authorization is complete, the server maintains the session securely using such tokens or equivalent credential-delegation mechanisms. This enables subsequent AI Prompts to be submitted across the selected AI Systems without requiring repeated user intervention. The server securely stores and refreshes such credentials, manages token expiration, and may enforce multi-factor verification as needed.

A person of ordinary skill in the art, based on the disclosures in this description and in light of existing teachings, would be able to implement these processes without undue experimentation. For example, various mechanisms for delegated authorization and secure token handling are described in U.S. Pat. No. 8,935,757B2 (OAuth framework), U.S. Pat. No. 9,237,156B2 (on-demand computing access using OAuth), U.S. Pat. No. 9,338,007 (secure delegated authentication for applications), and U.S. Pat. No. 10,922,401 (delegated authorization with multi-factor authentication), each of which is incorporated herein by reference in its entirety. This configuration ensures that login, password, or other authentication information is supplied only with user consent, and in accordance with such known practices, while enabling the orchestration of multiple AI Systems to proceed in the background in a seamless and transparent manner for the user.

In this manner, the AI Systems iteratively receive improved prompts (e.g., a consolidated prompt or each other's response) that cause them to focus on the areas of consensus and divergence. This requires each AI System to consider the results of other competing systems that rely on differing databases, biases, programming models, and system architectures. By iteratively presenting improved AI Prompts that consider and incorporate alternative answers from different AI Systems, the inventive systems and methods efficiently generate a more reliable response that encapsulates the core consensus across multiple outputs. This approach allows users to focus their research and follow-up efforts on genuinely contested points, making their inquiries more targeted and effective. Instead of sifting through vast amounts of conflicting information, users are guided to specific areas where clarification is most needed, thereby streamlining the research process and enhancing productivity.

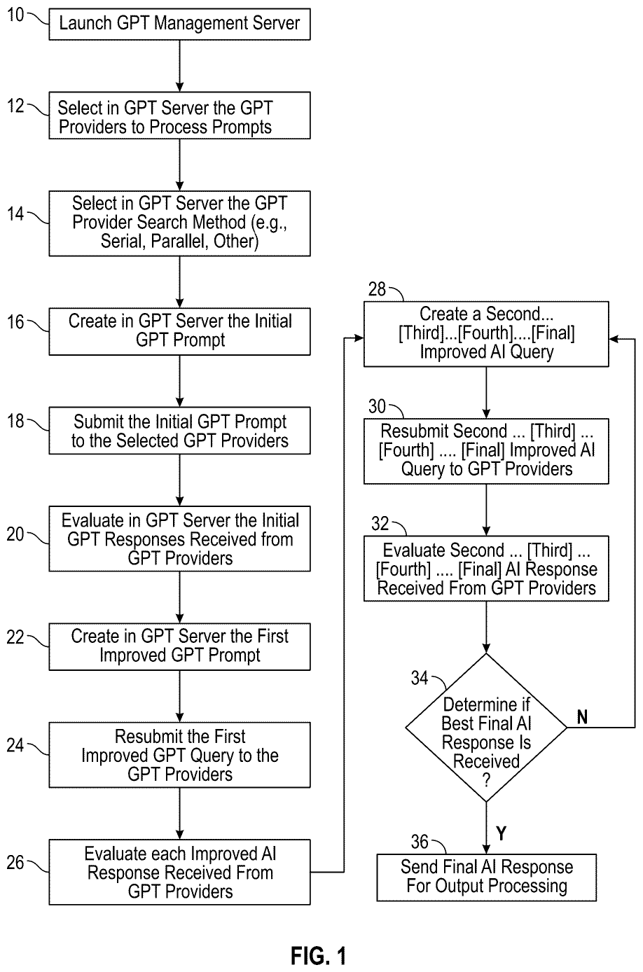

Referring now to FIG. 1, one example of a computer/software flow chart is shown, illustrating operations performed by the systems and methods disclosed herein to iteratively process an initial user prompt through multiple different AI Systems. As shown at operation 10, rather than directly engaging a single AI System, the user initiates a session by launching a GPT Management System that includes a GPT Management Server. The user may launch the GPT Management Server through a client application, such as a desktop or mobile program, or by logging into a secure web interface, which then establishes a session with the server.

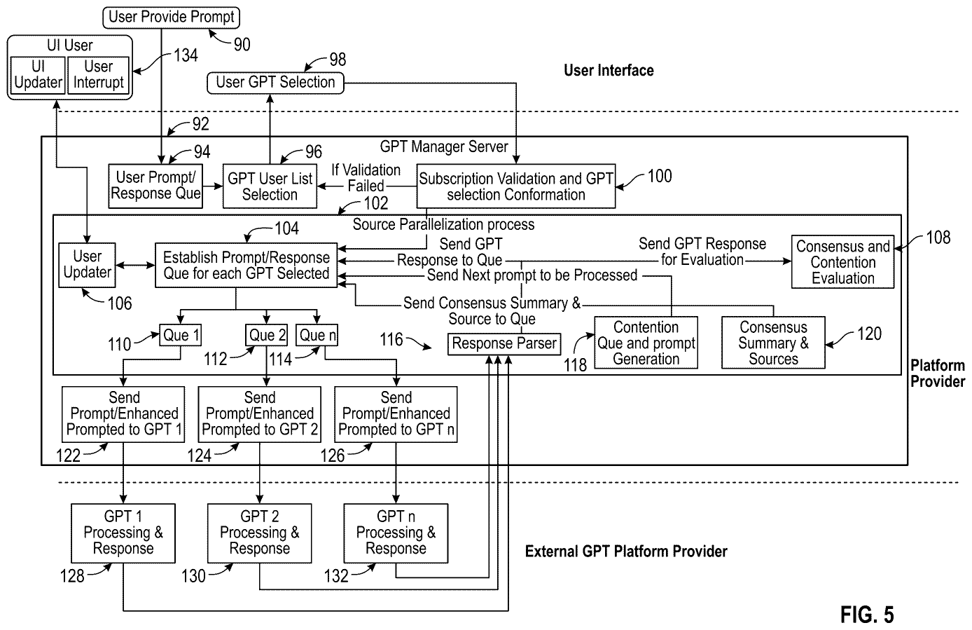

As described in more detail below in connection with FIG. 5, a GPT Management Server is implemented as a specially configured server computer system comprising one or more processors, memory, and non-transitory machine-readable storage. The server is programmed with machine-executable instructions that control the orchestration of prompt submission and response analysis across multiple commercially available AI Systems. The GPT Management Server includes routines for receiving user input, handling session state, communicating securely with external AI System providers, and processing iterative refinements of prompts and responses. In one configuration, the GPT Management Server is provided as a cloud-based service, so that initiating a session may involve authenticating the user and retrieving their subscribed AI System provider information.

In operation, the GPT Management Server serves as the control point for managing the prompt submission, analysis and iterative query process. As shown in FIG. 1 and described in more detail below, the server enables the user to select subscribed AI System providers (block 12), choose a processing mode (block 14), and permit prompt refinement and resubmission (blocks 16 through 32), until a final consolidated response is determined (block 34) and presented to the user (block 36). Importantly, the GPT Management Server does not require modification of any external AI System's internal architecture. Instead, it communicates with those systems through externally available APIs or interfaces, allowing orchestration to occur transparently from the user's perspective.

A person of ordinary skill in the art, based on the disclosures in this description and in light of existing teachings, would be able to construct and program the GPT Management Server without undue experimentation. See US20240256582A1 (“Search with Generative Artificial Intelligence,” filed Jun. 7, 2023) and U.S. Pat. No. 12,093,658B1 (“Systems and methods for implementing an artificial . . . prompt orchestration microservice,” issued Jul. 2, 2024), each of which is incorporated herein by reference in its entirety.

Referring again to FIG. 1, the GPT Management Server is optionally configured to allow the user at operation 12 to select from a group of commercially available AI Systems (“Selected GPT Providers”) that the user subscribes to (or that are publicly available without subscription), and to which the user desires to submit an AI Prompt. For convenience, the user's initial submission is referred to as the “Initial” or “First” AI Prompt. The GPT Management Server presents the available providers to the user through a graphical interface, menu in the client application, or a secure web portal. The GPT Management Server retrieves the user's subscription information and confirms the availability of the selected providers. The server records these user selections so that the Initial AI Prompt, and any subsequent refined prompts, can be submitted to the Selected GPT Providers during the orchestration process. In this manner, the user retains direct control over which AI Systems will participate, while the GPT Management Server manages the orchestration transparently in the background. In the alternative, the GPT Management Server can select which AI Systems to use as the Selected GPT Providers, or the Selected GPT Providers to use can be pre-programmed in the GPT Management Server.

Once the selections are made at operation 12, the GPT Management Server interacts with each chosen AI System as an external service through its available interfaces, while leaving the internal models and training of those AI Systems unchanged. The server transmits the Initial AI Prompt and subsequent refined prompts, receives the resulting responses, and orchestrates multiple rounds of interaction entirely outside the third-party AI Systems. No retraining, fine-tuning, or internal modification of the Selected GPT Providers is required. This configuration allows the GPT Management Server to treat each AI System as a black-box provider that may be flexibly selected, substituted, or combined, while ensuring continued operation even as the internal architectures of the providers evolve. In this way, the GPT Management Server achieves seamless integration with diverse commercial AI services in a non-invasive manner, preserving AI System provider independence and ensuring that improvements or changes on the provider side are automatically realized.

At operation 14, the GPT Management Server determines the processing mode (or multiple processing modes) to be used in analyzing the Initial AI Prompt. As discussed in greater detail below, the server may automatically select among serial, parallel, hub-and-spoke, or other available orchestration modes (or combinations thereof) based on the subject matter of the prompt, the user's preferences, or the known capabilities of the Selected AI System providers. In the alternative, the processing mode or modes can be selected by the user or preprogrammed in the GPT Management Server. In serial mode, prompts and responses may be passed sequentially from one provider to another. In parallel mode, the prompt may be distributed simultaneously to multiple providers for comparison. In hub-and-spoke mode, the GPT Management Server may consolidate responses from several providers, generate a revised prompt, and redistribute it for additional analysis. This flexibility enables the GPT Management Server to adapt the orchestration strategy to the nature of the query and the participating providers.

At operation 16, the GPT Management Server can optionally determine whether the Initial AI Prompt should be reformatted or adjusted to comply with the specific input requirements of each Selected AI System provider. It is well known that different AI System providers impose different requirements for prompt submission. For example, one provider may impose maximum character or word limits, another may require prompts to be provided in a structured data format such as JSON or XML, and another may restrict the use of certain symbols or formatting. Where such revisions are needed, the GPT Management Server reformats the user's submission so that it conforms to each provider's requirements while preserving the substance of the user's original content. These revisions ensure that the Initial AI Prompt is validly accepted by each Selected AI System and can be processed consistently across the different providers.

At operation 18, the GPT Management Server submits the Initial AI Prompt, as revised if needed under operation 16, to each of the Selected AI System providers. This submission can be transparent to the providers, with each provider processing the prompt as it normally would in response to a user query. Each provider independently processes the Initial AI Prompt using its own training data, algorithms, and internal architecture, and returns a corresponding response.

More specifically, the GPT Management Server evaluates at operation 20 the Initial AI Responses to identify, consolidate, and rank the areas of consensus and difference among the Initial AI Responses. Those areas of consensus and difference are consolidated, tabulated, and combined at operation 22 into an improved, revised, or consolidated submission that will be resubmitted to each of the Selected AI System providers. In one configuration, the GPT Management Server generates a structured representation of the results, ranking (and tracking) points of agreement and disagreement from the greatest degree of concurrence to the greatest degree of divergence. This improved, revised, or consolidated submission may be referred to herein as the First Improved AI Prompt, which may again be customized as needed to comply with the input requirements of each individual Selected AI System provider while retaining the substance of the user's original query.

At operation 24, the GPT Management Server submits the First Improved AI Prompt (as revised, if appropriate) to each of the Selected AI System providers. This resubmission may be transparent to the providers, which each receive and process the First Improved AI Prompt as though it were an ordinary user prompt. Each provider applies its own training data, algorithms, and internal logic to generate a new response to the First Improved AI Prompt.

At operation 26, the GPT Management Server evaluates the responses received from each of the Selected AI System providers to the First Improved AI Prompt. These responses are referred to as the First Improved AI Responses, as they reflect consideration of the First Improved AI Prompt rather than the user's Initial AI Prompt. In evaluating these responses, the GPT Management Server again identifies (and if desired tracks) areas of consensus and divergence, compares them against the earlier round of responses, and determines whether further refinement is appropriate. In this way, the system iteratively builds upon prior results, ensuring that each subsequent round incorporates both the user's original submission and the accumulated insights drawn from multiple AI Systems. In addition, the areas of consensus and disagreement among the queried AI Systems may be tracked and analyzed over time for grading and ranking their relative performance.

Continuing with FIG. 1, the GPT Management Server can be configured to iteratively repeat the orchestration cycle. At operation 28, the server generates a Second Improved AI Prompt, and, if needed, additional rounds of Third, Fourth, or further improved submissions. Again, each is formatted as needed for each Selected AI Provider. At operation 30, these improved prompts are resubmitted to the Selected AI System providers in the same transparent manner as described above. At operation 32, the GPT Management Server again evaluates the responses received from each provider to the improved prompt, again identifying consensus and divergence and incorporating those findings into subsequent iterations. In this way, the system progressively refines the analysis across multiple rounds of interaction, converging towards a final consolidated response.

At operation 34, the GPT Management Server determines when the iterative process has reached an acceptable degree of consensus and a sufficient vetting of areas of contention, thereby producing what is regarded as the best consolidated response to the user's Initial AI Prompt. Once this determination is made, the GPT Management Server at operation 36 formats, tabulates, and presents a comprehensive final AI Response to the user. This presentation may include, as described in more detail below, organization of the results by areas of consensus and contention, statistical rankings, and the association of supporting source information.

A person of ordinary skill in the art, given the present disclosure, would readily understand how to implement the operations of FIG. 1 without undue experimentation. The front-end and back-end components of the GPT Management Server, including user authentication, prompt submission, response receipt, and output formatting, can use established client-server and web-service technologies. Likewise, the operations of evaluating responses to identify areas of consensus and divergence can use text parsing, comparison, and ranking techniques that are within the current capabilities of commercially available natural language processing systems. Thus, the orchestration described in FIG. 1 builds upon known technologies in a novel configuration, enabling the systems and methods to be implemented using existing programming practices in view of the present specification.

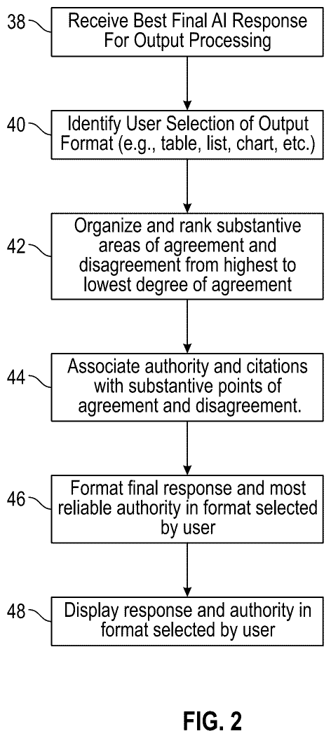

Referring now to FIG. 2, a more detailed description is provided of a user-facing presentation of the Final AI Response generated by the GPT Management Server. From the user's perspective, the interaction remains familiar: the user enters an Initial AI Prompt and ultimately receives a comprehensive response, without needing to learn new workflows or technical skills. The orchestration of multiple AI Systems and iterative refinement of prompts and responses can occur transparently in the background. However, the enhanced capabilities of the inventive systems and methods provide outputs enriched with consensus and divergence analysis, statistical rankings, source associations, and flexible formatting options. These improvements extend the user interface beyond conventional AI System outputs, delivering not only an answer, but also the context, supporting evidence, and areas of disagreement across providers.

A person of ordinary skill in the art, having the benefit of the present disclosure, would readily understand how to implement the operations described in connection with FIG. 2 without undue experimentation. Techniques for presenting results through menus, tables, charts, or narrative text are known in user interface and reporting design, as are methods for ranking outputs statistically and associating them with supporting source information such as citations, footnotes, or hyperlinks. After reading this specification, a person of ordinary skill in the art would be able to configure the interface elements and coordinate their use to present a Final AI Response that incorporates consensus and divergence analysis across multiple independent AI Systems. Accordingly, application of established interface and reporting practices, combined with the orchestration processes disclosed herein, enables the construction of the user-facing presentation shown in FIG. 2.

At operation 38, the GPT Management Server has created a Final AI Response that represents the best possible consolidated result after iterative processing by the Selected GPT Providers of the user's Initial AI Prompt and each of the subsequently refined prompts. This Final AI Response can integrate not only the areas of consensus reached across providers but also the areas of divergence revealed during multiple rounds of orchestration. As a result, the output delivered to the user can be both comprehensive and contextually informed, reflecting the full sequence of iterative refinements rather than a single round of responses.

At operation 40, the GPT Management Server optionally presents the user with a menu or interface enabling selection by the user of the format and degree of detail desired in the Final AI Response. Such interfaces may take the form of familiar drop-down menus, radio buttons, checkboxes, toggle switches, or tabbed views, all of which are widely used in user interface design. Through these controls, the user may choose whether to receive a concise summary, a detailed expanded response, or a balanced presentation. Different users may prefer different levels of detail depending on their purpose: for example, a casual user may prefer only a high-level summary, while a researcher may require extensive supporting detail, and another user may choose to omit contested points entirely to focus only on consensus. By accommodating these variations, the GPT Management Server ensures that the Final AI Response can be tailored to the needs of a wide range of users. In the alternative, the format and degree of detail desired in the Final AI Response can be preset by the user or the GPT Management Server.

At operation 42, the GPT Management Server may provide or list the areas of consensus and contention. This can be provided in a format that is statistically ranked from the points of greatest concurrence to the points of greatest divergence. The ranking itself may be displayed in formats known in the art, such as ordered lists, bar charts showing percentage agreement, confidence scores, or color-coded indicators. The user may select whether these rankings are included at all, and if included, whether they should emphasize consensus, divergence, or both. This flexibility allows the Final AI Response to be customized for different user preferences and use cases, such as decision-making, academic research, or quick information retrieval.

At operation 44, the GPT Management Server optionally organizes and associates the sources underlying the substantive answers presented in the Final AI Response. The sources may be presented in common citation formats such as inline links, footnotes, or endnotes, and may optionally be associated with identifiers of which Selected AI Providers contributed particular content. Optionally, the user may choose whether sources are displayed, and if displayed, whether they should be presented minimally (e.g., a simple link), or comprehensively (e.g., formal citations with metadata). By making the inclusion of sources user-selectable or user-adjustable, the system allows casual users to receive a streamlined output, while providing researchers or professionals with traceable references and attribution.

At operation 46, the GPT Management Server formats and organizes the Final AI Response, including in accordance with the user's selections if applicable, and at operation 48 displays the response to the user. The formatting may include presentation as a table, a chart, or narrative text, which may depend on user preference. The user may also specify whether the output should identify which Selected AI Providers contributed to specific areas of consensus or contention. If the user makes no such selections for formatting, citations, or attribution, the GPT Management Server automatically organizes and presents the Final AI Response in a default manner determined to be most useful, ensuring that the system always produces a coherent, user-friendly output.

The particular interface elements and presentation options described above are provided as examples only. The present systems and methods are not limited to drop-down menus, lists, charts, footnotes, hyperlinks, or any other specific implementation. A wide range of equivalent user interface techniques and reporting formats may be employed without departing from the scope of the disclosed systems and methods. What is important is that the GPT Management Server enables the user to control, to the extent desired, the format, level of detail, and supporting information included in the Final AI Response, whether through the specific examples set forth herein or through other known or later-developed interface conventions.

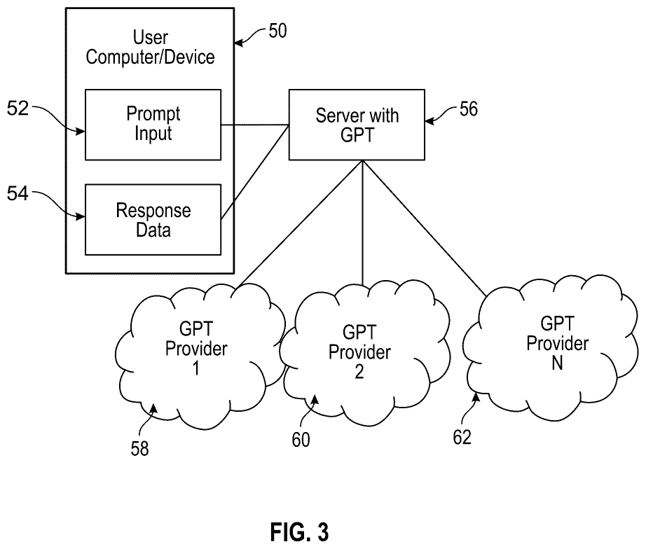

Referring now to FIG. 3, an arrangement is shown for transmitting user prompts from a local device to the GPT Management Server and routing them to multiple AI System providers for processing. The GPT Management Server is configured to integrate multiple GPT instances that streamline and enhance the user experience and offers a robust backend system capable of managing complex queries efficiently.

As shown in FIG. 3, the user operates a computing device, such as a computer, tablet, smartphone, or other electronic device identified at 50 to input the prompt 52 to the GPT Management Server 56. The user/computing device 50 includes an application with a graphical user interface (GUI), identified at 52, through which the user may enter a prompt to be processed by the GPT Management Server 56. The same application provides a corresponding GUI display at 54 to present results returned from the GPT Management Server 56. Such user-interface (GUI) applications and interfaces are available for client-server architectures. A person skilled in the art with the benefit of this disclosure would, without undue experimentation, be able to implement such interfaces as a desktop program, a mobile app, or a web-based interface.

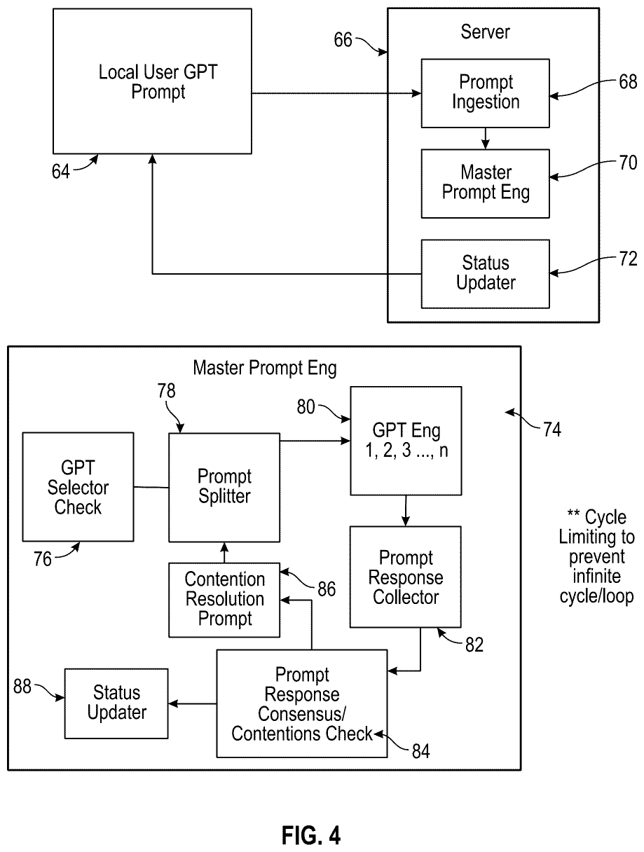

The GPT Management Server 56 is responsible for receiving the user's prompt transmitted from device 50, orchestrating its distribution to the multiple AI System providers (shown as GPT Providers 1, 2, and “ . . . N” (58, 60, 62)), and transmitting consolidated results back to the user device 50. The GPT Management Server 56 operates in the manner described in greater detail above with reference to FIGS. 1 and 2, and also below in FIGS. 4 and 5. The GPT Management Server is configured to handle prompt preparation, submission, response evaluation, and iterative refinement without requiring any modification to the internal architecture of the external AI Systems. The GPT Management Server is therefore configured to integrate multiple GPT Providers (58, 60, 62) to streamline and enhance the user experience.

The systems and methods shown in FIG. 3 can also be configured to employ multiple orchestration and processing strategies, including parallel, token-ring (serial), linear serial, and hub-and-spoke methods. The GPT Management Server 56 is responsible for coordinating and managing the processing logic across all AI Systems, and selects one or more orchestration modes—parallel, sequential (token-ring), or adaptive (hub-and-spoke)—each suited to different prompt types or system configurations. These orchestration strategies are powered by the internal components of the GPT Management Server 56, which are shown in expanded detail in FIG. 4, and the strategies may be used alone or in combination.

For example, in the parallel orchestration mode, the Initial AI Prompt is transmitted simultaneously to a selected set of external GPT Providers (e.g., 58, 60, 62), all of which return their responses independently to the GPT Management Server 56. This configuration enables fast, concurrent analysis of multiple AI models.

The parallel processing used in this mode can be accomplished through multiple methodologies, each offering unique advantages depending on the specific needs of the application. Multi-threading is one approach, allowing multiple threads to run concurrently within a single process. This results in an efficient solution for tasks that require shared memory. Multi-processing, on the other hand, involves running multiple processes simultaneously, each with its own memory space. This mode is particularly useful for tasks that benefit from parallel execution without shared state. Numerous other modes can also be employed.

Cloud-based solutions also offer a scalable alternative, leveraging services like AWS Lambda or Google Cloud Functions to execute operations in parallel without the need to manage the underlying infrastructure. These serverless options are ideal for applications requiring elasticity and low latency. Additionally, traditional cloud computing services can be utilized to deploy virtual machines or containerized instances, providing a flexible environment for both multi-threaded and multi-processed tasks, allowing the system to scale horizontally as demand increases.

In this regard, for clarity, and consistency with the meaning of terms throughout this disclosure, the phrase “GPT Management Server” as used in herein is not intended to refer solely to a single physical or virtual server. Instead, it encompasses any suitable (and known) implementation—whether centralized, distributed, cloud-hosted, containerized, or otherwise—that is capable of executing the processing operations described herein. These may include, without limitation, traditional server hardware, cloud infrastructure, multi-instance configurations, scalable computing environments, or integrated processing circuits or software programs within a broader application platform. The term is used in a plain and customary manner, as understood by a person of ordinary skill in the art, and is not restricted to any particular hardware configuration or deployment model.

When this application refers to a “processing circuit or software program” it is referring to structural circuits (for example, software code or instructions residing on a non-transitory computer-readable storage medium such as a CPU, a system on a chip, or other such processor) or structural software programs residing on a non-transitory computer-readable storage medium (for example, programming code such as JavaScript, python, BASIC, or other known programming languages or APIs), and it describes the capabilities and arrangements of those processing circuits or software programs in a way that further defines their structure. When using the terms “processing circuit or software program,” unless stated otherwise expressly, the inventor does not intend to invoke the provisions of 35 U.S.C. § 112(f) or use those terms as “nonce” words.

In combination with (or as an alternative to) parallel processing of the query, the systems and methods can also be configured to employ a single-threaded processing mode (akin to a token ring architecture) to receive and process a user prompt in a sequential manner. In this manner, the output from one GPT model is iteratively enriched before being passed on to the next. In this mode, each GPT receives not the original prompt, but the progressively refined response generated by the preceding model. This sequential approach allows each GPT to contribute its unique insights and strengths to the evolving answer, enriching it layer by layer. In this single-threaded mode, the systems and methods are further configured so that process continues through a predefined number of cycles or until the system detects a sufficient level of consensus among the models, ensuring that the final output represents a well-rounded and thoroughly vetted response.

This sequential form of the systems and methods can be particularly effective for prompts that benefit from incremental refinement, as each model builds on the insights of the previous one, gradually honing in on a more accurate and coherent conclusion. Although potentially slower than parallel processing, this token ring approach offers a meticulous and deliberate path to consensus, making it ideal for complex queries requiring deep analysis and iterative enhancement.

As yet another alternative (or in addition or combination to the above), the systems and methods shown in FIG. 3 can also be configured to use a hub-and-spoke single-threaded processing mode. In this mode, the GPT Management Server operates as a form of “central hub,” receiving and analyzing responses from each GPT Provider independently. After the user submits a prompt the GPR Management Server sends it to a selected first of the GPT Providers and evaluates the response. In this manner, based on the content and quality of the response, the GPT Management Server then decides the next best GPT Provider to query, directing the enriched or original prompt to another GPT in the sequence. This process repeats until the master determines that sufficient consensus has been reached or the required depth of analysis is achieved.

In a hub-and-spoke mode of operation, unlike the token-ring example (where each GPT Provider typically gets an opportunity to contribute), the hub-and-spoke approach can employ an unequal distribution of queries among selected models. This method can lead to quicker consensus by focusing on the most promising responses early on, potentially bypassing less relevant or redundant contributions.

Each of the above approaches can be used alone or in combination and can be tailored to fit the specific requirements of the backend system, ensuring that it remains both efficient and adaptable in handling complex queries across a distributed environment. As also shown in FIG. 3, the consolidated result of these operations is returned to the user device, and at 54, the application on the device displays the final response to the user. As described above, this response may incorporate the enriched features described in connection with FIG. 2, including consensus and divergence analysis, ranked results, and associated source information, presented in a format chosen by the user or determined automatically by the GPT Management Server.

Referring now to both FIG. 3 and FIG. 4, the GPT Management Server (labeled 66 in FIG. 4 and 56 in FIG. 3) coordinates the flow of prompts and responses. The backend system of the GPT Management Server is robust and scalable, capable of managing complex queries from many users simultaneously. The backend may include a load balancer within the GPT Management Server (56/66) that distributes incoming requests evenly across multiple GPT instances, thereby optimizing performance and preventing any single instance from becoming a bottleneck.

A query management processing circuit or software program within the GPT Management Server (56/66) can orchestrate the handling of user submissions by dividing prompts into smaller, manageable tasks that can be processed in parallel. The query management processing circuit or software program ensures that responses from different GPT instances are coherently assembled and returned to the user. An instance manager can be included to further control allocation and deallocation of GPT instances such as those shown at (58, 60, 62), scaling resources dynamically according to demand to maintain high availability and responsiveness.

To improve efficiency, the GPT Management Server (56/66) may employ a data cache layer for storing frequently accessed data and responses, reducing redundant processing and speeding up repeat queries. A high-performance database may also be connected to the server to store user queries, session information, and related metadata for fast retrieval. An analytics engine may further analyze user behavior, system performance, and query trends, enabling continuous optimization. To ensure resilience, the GPT Management Server (56) may also include failover and redundancy features, allowing service continuity in the event of hardware or software failures.

The user interface terminal 64 shown in FIG. 4 corresponds to user device 50. The terminal 64 may be a laptop, desktop computer, mobile device, or virtual client environment. It serves as the endpoint through which users interact with the GPT Management Server 66, including entering prompts and receiving AI-generated results. The GPT Management Server 66 comprises the core orchestration and processing backend. It includes a prompt ingestion interface, which may be implemented as an API endpoint, HTTPS form POST, or other suitable data submission method. This component receives user prompts from user input device 64 and initiates the prompt processing lifecycle.

Within the GPT Management Server 66, the prompt lifecycle begins at component 70, which represents the initiation point of the core processing workflow. This is where the orchestration logic evaluates the prompt and determines appropriate handling paths, such as internal processing or distribution to external GPT systems. A more detailed breakdown of this lifecycle is represented at component 74, which provides internal stages of analysis, decision-making, and response routing. This may include modular subcomponents responsible for formatting, logging, and decision tree execution based on prompt content and user profile data. To ensure accurate and efficient processing, the system typically incorporates a GPT Selector Check processing circuit or software program 76, which determines which GPT systems are to be engaged for the current prompt. As described above, GPT systems vary in specialization, performance, and suitability for particular tasks. For example, some are tuned for code generation, others for legal analysis, creative writing, summarization, etc. Accordingly, the GPT Selector Check 76 can be implemented to apply criteria such as GPT capabilities, domain specialization, historical accuracy, and user preferences to help select optional and appropriate engines to submit a prompt.

Once a set of GPTs is selected (either by the user or by the disclosed systems and methods), a Prompt Preparation and Iteration processing circuit or software program 78, or prompt splitter, formats and normalizes the prompt for compatibility with each targeted GPT system. This includes handling syntax, prompt segmentation, token limits, and insertion of system-level control parameters to maintain contextual continuity across multiple interactions. During this process, the processing circuit or software program 78 tracks the prompts via known methods, such as a data cache, data store, cloud service, relational database, etc.

The server then dispatches prompts using an internal thread or session manager, not shown in the figure, enabling either parallel or sequential submission to selected GPT endpoints. Results are collected and evaluated for agreement or divergence among the outputs. In cases where significant variation is detected among GPT responses, additional processing circuits or software programs (such as consensus analyzers or follow-up prompt generators) may be invoked. These are described in greater detail elsewhere in the specification.

The user interface terminal 64 receives the final result after completion of processing and consolidation operations. This may include providing the result transparently in the “usual” manner known to the user, or with more detail, for example, in side-by-side outputs, annotations of divergence, or metadata indicating which GPTs contributed to the final answer set. In this configuration, FIGS. 3 and 4 collectively illustrate an integrated prompt orchestration system that leverages multi-GPT selection and lifecycle control to deliver tailored AI-generated outputs via a streamlined, centralized user interface.

Upon receiving responses from one or more selected GPT systems, the system invokes the Response Packager 80, which formats and encapsulates the returned data into structured response packages. These may include metadata such as timestamps, model identifiers, token usage, and any associated flags or errors, organizing them for downstream analysis. The packaged responses are then passed to the Prompt Response Collector 82. This component is responsible for error handling and correlating each received response with its originating prompt. In essence, it ensures responses are correctly aligned within the timeline of prompt iterations handled by Prompt Preparation and Iteration 78.

The validated responses are next processed by the Consensus/Contention Evaluator 84, which serves as a mediator and evaluator. This component determines whether the responses from different GPTs exhibit sufficient agreement or require further reconciliation. It may operate under a user-defined congruency threshold or delegate discrepancy resolution to another GPT. The evaluator also detects hallucinations or unreasonable inferences, and produces metrics such as Integrity and Relevance scores to help assess AI output confidence.

If consensus is achieved, the system generates a final response and provides feedback to the user via the Status Update Handler 88. This processing circuit or software program issues real-time micro-updates during processing and also allows user-initiated interrupts. These interrupts may be configured to, for example, force output delivery, adjust GPT cycles to manage cost or eliminate inconsistent GPTs, trigger a source-check, or shift the processing mode. If the Consensus/Contention Evaluator 84 determines that the agreement threshold has not been met, the system generates a follow-up prompt using the Contention Prompt Generator 86. This prompt targets the unresolved divergence and is treated as the final action before a new prompt life cycle is initiated via Prompt Preparation and Iteration processing circuit or software program 78. The above cycle will continue until a threshold has been reached or a user interrupt command is issued.

Thus, as described above, when a user provides a prompt and selects which GPT Provider (and, if desired, models) they wish to use, the backend can query these models in accordance with the description above, aggregating their responses to identify areas of consensus and pinpoint contention points. The backend system initiates a process designed to extract the most accurate and nuanced responses possible. The first operation in this process is to queue the prompt, ensuring it is properly staged for parallel, serial, or hub-and-spoke processing. Once queued, the system may modify the prompt as necessary before sending it to each selected GPT model in accordance with the selected mode. This dispatch allows the backend to efficiently retrieve responses from all models in accordance with the selected model.

After collecting the responses, the backend runs a detailed comparison to analyze the outputs. This analysis focuses on identifying areas of “consensus,” where the models agree, and “contention,” where their responses differ. The distinction between both consensus and contention is critical for understanding the range of perspectives provided by the models. These areas of consensus and contention among the various responses are tracked, tabulated and consolidated by the GPT Management Server system.

In cases where contention is detected, the system generates a new prompt specifically designed to address the areas of disagreement. This new prompt is then sent back to all the GPT models (in the then-selected mode), targeting the points of contention to further clarify and resolve these differences. This cycle of refinement and re-querying continues iteratively, allowing the system to progressively narrow down and reconcile the contentious areas while also testing and retesting the areas of consensus. Also, to avoid false areas of consensus, the system can include in reformulated prompts a request that the areas of consensus be rechecked and confirmed. In addition, the refined prompts can request that citations and support for areas of consensus be confirmed, rechecked, and provided as authority.

This process can persist iteratively until one of several possible conditions is met: a preset cycle limit is exceeded, a user interruption is detected, a consolidated response is generated representing a statistically acceptable degree of consensus, a point of diminishing returns in response variance is reached, or all contention points are resolved. By implementing this iterative method, the systems and methods ensure that the final output is not only comprehensive but also reflects a balanced consideration of all possible viewpoints, providing the user with the most informed and reliable response possible.

By analyzing where the models disagree, the systems and methods can initiate an “intermediate prompt enrichment” process, independently refining and resubmitting prompts to the models in a parallel, series, via hub-and spoke, or any other desire manner. The systems and methods are further configured so that the iterative process can continue until a resolution is reached, ensuring that the most accurate, comprehensive, and coherent response is delivered to the user. The entire process can be seamless, making it transparent to the user while significantly enhancing the quality of the output by leveraging the strengths of multiple models in harmony.

Referring more specifically to FIG. 4, the configuration and operation of the subsystems within the GPT Management Server 66 are detailed below with explicit reference to the labeled components. These descriptions supplement the broader operational explanation provided above and highlight how each processing circuit or software program supports orchestration strategies such as parallel, token-ring, and hub-and-spoke architectures, as previously described.

The system is accessed via a User Device Interface 64, which serves as the entry and exit point for user interactions. Through this interface, users submit initial prompts and receive final outputs, which may be enriched with consensus indicators, citation formatting, or other configurable elements, as noted earlier.

Within the GPT Management Server 66, the User Prompt Receiver 68 accepts incoming prompts, acting as a gateway that validates and forwards data to the orchestration system. The GPT Engine 70 serves as the central processor, determining orchestration mode (e.g., parallel or sequential), refining prompts as necessary, managing communication with external GPT Providers, and coordinating lifecycle progression from initial input to final convergence.

A Status Updater 72 connects to the GPT Engine to provide real-time progress feedback to the user—offering information about prompt handling status, detected disagreement, or process completion. An Expanded View processing circuit or software program 74 reveals internal orchestration and analysis logic, illustrating the division of tasks across specialized subcomponents.

The GPT Selection Verification processing circuit or software program 76 authenticates selected GPT Providers by checking availability, capability, and credentials. It ensures that the system engages with valid and compatible models. The Prompt Preparation and Iteration processing circuit or software program 78 generates refined prompts, either as initial standardizations or follow-ups to resolve disagreement. This processing circuit or software program is responsible for tailoring inputs to optimize relevance and clarity per provider.

The GPT Thread Management Process 80 handles the distribution of prompts and tracking of responses, supporting parallelism and asynchronous workflows. Once results are received, the Prompt Response and Correlation Process 82 aligns and analyzes content, highlighting agreement and divergence across providers. These outcomes are then logged by the Consensus and Contention Storage Engine 84, which preserves not only results but associated metadata for traceability, such as model attribution, scoring, and source references.

When divergence remains unresolved, the Contention Resolution Process 86 works in coordination with the prompt generator and thread manager to issue refined queries aimed at reconciling disagreements. Throughout this workflow, the Status Updater 88 delivers detailed consensus metrics and system feedback to the user, either progressively or upon completion, via the user interface 64.

In this manner, the modular architecture of the GPT Management Server 66 enables dynamic, explainable orchestration of multiple GPT Providers. Each labeled component contributes to a framework that can adapt to external systems as black-box models—without retraining—while maintaining compatibility with a range of AI infrastructure formats and usage scenarios.

Referring more specifically to FIG. 4, the configuration and operation of the subsystems of the GPT Management Server 66 will again be described with reference to the identified processing circuits or software programs and components. The GPT Management Server 66 is responsible for orchestrating prompt distribution, response refinement, and final output assembly across multiple external GPT Providers. The components shown within GPT Management Server 66 enable execution of all orchestration strategies described in the specification—including parallel, token-ring, and hub-and-spoke modes—as described above.

The system is accessed via a User Device Interface 64, which supports user interactions for both input and output. Through this interface, the user can submit an Initial AI Prompt and receive the Final AI Response, which can be enriched with consensus indicators, formatting, or citations as selected or configured, as discussed above.

In the example shown in FIG. 4, within the GPT Management Server 66, the User Prompt Receiver 68 handles incoming prompts. It acts as the gateway to the system, validating and forwarding prompt input to the server's orchestration logic. The GPT Engine 70 serves as the core processing unit. It coordinates prompt refinement and customization, orchestration strategy, determines whether to operate in a parallel or sequential mode, and oversees communication with selected GPT Providers. This engine is responsible for routing prompts, aggregating responses, and deciding when convergence or termination criteria have been met.

A Status Updater 72 is connected to the GPT Engine and provides real-time feedback to the user, such as progress indicators or notices regarding processing delays, detected disagreement, or completion status. An Expanded View of the GPT Management Server is shown as element 74, revealing its internal processing circuits or software programs. Each processing circuit or software program supports a distinct operation in the orchestration and analysis pipeline. The GPT Selection Verification processing circuit or software program 76 verifies the identity, capabilities, and current availability of candidate GPT Providers. It may also manage credentials or authentication keys for secure access to external models.

The Prompt Preparation and Iteration processing circuit or software program 78 is responsible for refining the user's prompt when needed. Based on response content or system logic, this processing circuit or software program generates Improved GPT Prompts tailored to elicit clarification, resolve disagreement, or promote convergence among providers. The GPT Thread Management Process 80 establishes and maintains communication sessions with individual GPT Providers. It assigns prompts to threads, handles asynchronous responses, and tracks session metadata across one or more rounds of interaction.

Once responses are received, the Prompt Response and Correlation Process 82 aligns and compares the content of the returned outputs. It identifies consistent findings, areas of divergence, and indicators of quality or relevance, forming the analytical basis for consensus determination. These aligned results are passed to the Consensus and Contention Storage Engine 84, which maintains structured records of agreement, disagreement, and supporting metadata (e.g., attribution, source references, statistical rankings). This engine supports auditability and transparency in the final response generation.

The Contention Resolution Process 86 analyzes disagreement areas flagged by the correlation process and interacts with both the prompt generator and thread manager to issue additional queries. This processing circuit or software program enables the system to dig deeper into contentious topics and improve confidence in the Final AI Response. The Status Updater 88 supplements the earlier updater (72) by presenting consensus and contention metrics, rankings, and other processing summaries to the user. This may occur continuously during processing or as part of the final formatted output delivered via the user interface 64.

In this manner, the GPT Management Server 66 implements a modular orchestration framework that enables transparent, dynamic interaction with commercially available GPT Providers. The element of the block diagram generally correspond to the orchestration strategies described in connection with FIG. 3. The server can operate without modifying or training the external models, treating them as independent, black-box systems, and maintaining full compatibility with evolving AI infrastructures.

A person of ordinary skill in the art, having the benefit of this disclosure, would understand how to implement the various orchestration processes described in connection with FIGS. 3 and 4 without undue experimentation. Techniques for parallel, token-ring sequencing and hub-directed query management are known in computing and network design. In light of this specification, such a person would also be able to configure and program the GPT Management Server 56/66 to carry out the token-ring and hub-and-spoke modes illustrated in FIG. 4.

Referring now to FIG. 5, a more detailed block diagram is shown illustrating the structural arrangement of the GPT Management Server in relation to the user interface, the orchestration processes carried out by the server, and the external GPT platform providers. The figure is divided into three general portions: (i) a top portion representing the user interface layer, (ii) a middle portion representing the GPT Manager Server and its internal orchestration processes, and (iii) a lower portion representing the external GPT platform providers that process prompts and return responses. Other arrangements may be used without departing from the disclosed systems and methods.

At element 90, a user provides a prompt through a local device. This prompt is received by the User Updater 134, which includes an updater processing circuit or software program and an interrupt handler for receiving user input or user interruptions. The User Updater 134 bridges the user interface layer and the GPT Manager Server 92, passing user input into the orchestration process and returning updates back to the user interface. At element 92, the GPT Manager Server receives the user's prompt. The prompt is then placed into a Prompt/Response Queue 94, which stores incoming prompts awaiting processing. At element 96, a GPT User List is presented, showing the AI System providers available to the user. At element 98, the user selects one or more GPT providers to be used for the session. Alternatively, the AI System providers may be pre-selected before the session, or selected automatically by the GPT Manager Server.

Once a provider is selected, the GPT Manager Server validates the subscription and provider account status at element 100. If validation fails, the process is interrupted and reported to the user through the User Updater 134. If validation is successful, the prompt and provider selection proceed into the Source Parallelization Process 102.

Within this orchestration process, the server establishes a Prompt/Response Queue for each selected GPT provider at element 104. At element 106, the User Updater 134 exchanges information with this orchestration process to handle user interrupts or adjustments during execution. At element 108, a Consensus and Contention Evaluation processing circuit or software program operates to separate agreements from disagreements among the responses received.

Additional and optional subcomponents are also shown within this orchestration portion. At elements 110, 112, and 114, queues are maintained for the respective selected GPT providers (e.g., GPT 1, GPT 2, GPT N). These queues maintain the history of prompts and responses exchanged with each provider. At element 116, a Response Parser sorts and correlates the responses received. At element 118, a Contention Queue and Prompt Generator creates additional prompts to clarify or resolve disagreement points. At element 120, a Consensus Summary and Source Store compiles points of agreement along with associated source references or citations.

At elements 122, 124, and 126, the GPT Manager Server includes respective Provider Engines that send prompts (or enhanced prompts) to external GPT platforms. Each engine ensures that prompts are properly formatted and transmitted, and that connectivity errors are resolved. At elements 128, 130, and 132, the corresponding external GPT platform providers are shown, each representing an independent third-party AI System that processes the received prompt and returns a response. Any number and combination of AI System providers may be used—either in series, in parallel, or in hub-and-spoke (or other) configurations—as implemented by or determined by the GPT Management Server.

The results of these external processing operations are returned to the GPT Management Server, parsed at element 116, and fed back into the consensus and contention evaluation loop at elements 108, 118, and 120. Optionally, throughout this process, the User Updater 134 continues to operate as the structural bridge between the orchestration layer and the user interface layer, supplying real-time updates to the user device, including status information, progress indicators, and interim results, thereby keeping the user informed while orchestration continues in the background.

In this manner, FIG. 5 structurally and procedurally shows one example of how the GPT Management Server receives and queues user prompts, validates provider selections, orchestrates prompt distribution across multiple external GPT platforms, and evaluates the responses iteratively to generate consolidated results. The drawing shows a specific structural arrangement of queues, parsers, evaluators, and engines that cooperate with user-facing and provider-facing processing circuits or software programs. This arrangement exemplifies how the disclosed systems and methods may be implemented using known server and distributed computing components, guided by the orchestration methods described above.

A key objective of the disclosed systems and methods is to address two persistent challenges in AI performance: hallucination and response integrity. Hallucination occurs when an AI system generates factually incorrect or fabricated content. One known mitigation technique is the use of Retrieval-Augmented Generation (RAG) systems, which enhance factual grounding by linking responses to an external, verifiable knowledge base. However, RAG's effectiveness is inherently constrained by the scope, quality, and recency of its indexed data. While RAG can offer certain benefits—such as enabling independent verification when its indexed sources overlap with the model's foundational training data, and expanding the breadth of a model's output when introducing entirely novel content—these advantages are conditional and limited by the content available within the retrieval corpus.

By contrast, the disclosed systems and methods employ a multi-model orchestration framework that compares, refines, and reconciles outputs from multiple independent AI models or subsystems. This design provides a more robust and adaptive mechanism for improving both factual accuracy and contextual relevance. Each AI model may respond differently to the same prompt due to variation in training data, architecture, and parameter count, resulting in diverse outputs that can be evaluated across key metrics such as Perplexity (model confidence), Relevance (alignment with the prompt), and Bias (fairness or neutrality).

These differences, among the others disclosed herein and which stem from each model's training methodology and architecture, become assets in the evaluation process rather than liabilities. Moreover, the invention allows for hyperparameter tuning—adjusting external configuration settings—to control the behavior of each model or subsystem and optimize the quality of their outputs. This multi-dimensional, iterative approach allows the system to detect inconsistencies, reduce hallucination, and enhance response integrity in a way that RAG alone cannot achieve.

While much of the preceding discussion has addressed submitting prompts to and comparing responses from multiple, independently operated AI systems—each with its own subscription model, architecture, training data, algorithms, and biases—the disclosed systems and methods are equally applicable to a single AI platform comprising multiple independently operable AI Subsystems. In such configurations, a single AI provider may offer multiple targeted subsystems, each optimized for a particular domain. For example, AI Subsystem 1 may be tailored for academic use, Subsystem 2 for corporate environments, Subsystem 3 for creative domains such as art and music, Subsystem 4 for educators, and Subsystem 5 for students. Each of these subsystems may differ in its training sources, algorithms, internal databases, and learned biases. For instance, Subsystem 1 may prioritize academic journals, Subsystem 2 may emphasize business reports, and Subsystem 3 may rely on creative content databases.

Access to one or more AI Subsystems may be customized per user based on subscription level, user credentials, or organizational affiliation. In some embodiments, users may be allowed to manually select which AI Subsystem to engage for a particular prompt. In others, the system may automatically route the prompt to an appropriate Subsystem based on prompt content, user profile, or prior interaction history. For instance, a prompt concerning business strategy may be directed to Subsystem 2 without user intervention.

These capabilities do not require separate AI providers. The GPT Management Server, as described throughout this disclosure, may be configured to operate within a single AI platform and serve as the orchestration layer that manages prompts across multiple internal AI Subsystems. In this configuration, the server may act as a native component of the provider's infrastructure or as a user-side controller interfacing with the provider's multi-subsystem architecture.

The disclosed systems may be implemented to process user queries across such AI Subsystems using the following workflow: (1) receiving a prompt at a server and distributing it to multiple distinct AI Subsystems; (2) receiving the resulting responses and performing comparative analysis to identify areas of agreement and disagreement; (3) generating and submitting refined prompts targeting the divergent portions of the output; (4) directing the AI Subsystems to reanalyze the improved prompt; (5) optionally repeating this cycle until a stopping condition is met—such as achieving a consensus threshold, detecting diminishing returns, or reaching a maximum iteration limit; and (6) presenting a consolidated response to the user that highlights both consistent and conflicting viewpoints from the respective Subsystems.

Applying this process to Subsystems 1-5, for example, would yield a result set that reflects both convergence and divergence in how distinct domains interpret a given prompt. An economics prompt submitted in this framework might return materially different responses from a corporate Subsystem compared to a student-focused Subsystem, revealing nuance across educational and practical contexts.

Similarly, AI Subsystems may be trained on regionally focused datasets, introducing geographic perspectives into the response landscape. For example, Subsystem 1 might prioritize North American sources, Subsystem 2 European materials, and Subsystem 3 Asian content. A current-events prompt routed to these Subsystems would generate a regional analysis, showing how the same topic is framed differently around the world. Such comparative insight can help users distinguish between universally accepted facts and culturally or geographically influenced interpretations, enhancing transparency, media literacy, and trust in AI outputs.

FIG. 5 illustrates one exemplary deployment architecture for the disclosed systems and methods. The user interface layer (elements 90, 96, 98, and 134) operates as the entry and feedback point for the end user. The interface may be implemented using any suitable User Interface/User Experience (UI/UX) design, provided it enables three core functions: (i) entry of a user prompt (via element 90), (ii) configuration of prompt processing preferences or provider selection (via element 98), and (iii) delivery of output and user interrupt commands (via element 134).

The GPT Manager Server 92 is architecturally and functionally separate from the UI layer but may be integrated through a well-defined interface such as an API endpoint or other application-layer mechanism. The server's first point of interaction is Prompt/Response Queue 94, which retains all user prompts and corresponding AI responses. This queue acts as a stateful transcript store, essential for enabling prompt iteration and follow-up continuity. It may be implemented using any known queuing, database, or session management technique.

Element 96, the GPT User List Engine, is responsible for associating each prompt session with a selected set of AI system providers. It maintains subscription state, access permissions, and session history. In conjunction with element 98, it allows users to manually select or preconfigure which GPT models or subsystems to engage. When the selected model is a paid or restricted-access provider, element 100 performs validation against the user's subscription status. Any errors in validation are returned to the UI layer via element 134.

Once validation is complete, element 102 coordinates prompt distribution to each selected GPT engine in parallel. These prompts may be routed through intermediate processing circuits or software programs such as Prompt Preparation Services 118, which normalize the prompt for each GPT's input format. The prepared prompts are dispatched through queue managers 110, 112, and 114, corresponding to each selected AI system. These queues track asynchronous or synchronous interactions and are updated in coordination with element 104, which also provides status updates via element 106.

The downstream elements 122, 124, and 126 represent the provider engines that transmit prompts to external GPT platforms (elements 128, 130, and 132). These components are functionally similar to the Prompt Thread Manager 80 described in earlier sections and are responsible for communication integrity, retry logic, and transport-layer handling.

Once responses are returned, they are collected at element 116, the Response Parser, and forwarded to element 108, the Consensus and Contention Evaluator. Here, conflicts among returned responses are assessed using configured evaluation logic. The evaluator may utilize a dedicated AI model or external decision engine to determine resolution outcomes.

All response activity is tracked and recorded by element 118, which may function both as a processing intermediary and as a long-term storage mechanism for orchestration logs, depending on the system configuration. After responses are parsed and reconciled, the finalized output is assembled by element 120, the Consensus Summary and Source Store, which consolidates agreements, annotated divergences, and any supporting citations. This composite result is then passed to element 104, which handles coordination of final delivery to the user interface through element 134, ensuring the user receives timely and transparent output enriched with processing context and decision insights. The tracked data may also be configured for provision to the various AI System Providers that are queried.

More specifically, as described throughout the present disclosure, the orchestration system may generate and retain a wide range of operational and performance data during the lifecycle of prompt processing. This data may include: (i) raw user prompts and their associated metadata (timestamps, session identifiers, user-selected GPTs); (ii) provider-specific responses, including model identifiers, token counts, and output content; (iii) error logs indicating response formatting issues, connectivity failures, or subscription validation problems; (iv) consensus and contention determinations, including quantified agreement scores and flagged divergent statements; (v) refined or reformulated prompts issued to resolve disagreement; (vi) response metrics such as Perplexity, Relevance, and Bias evaluations if computed; and (vii) final consolidated outputs with traceable attribution to contributing models. This information, which may be captured by components such as the Prompt/Response Queue (94), Response Parser (116), Consensus Evaluator (108), and Summary Store (120), can be stored, anonymized, and optionally made available to third-party AI system providers. Such data can assist those providers in monitoring the comparative performance of their models across diverse user scenarios, identifying strengths and weaknesses, and improving future iterations of their systems. Access to this data may be granted via subscription or analytics service models administered by the GPT Management Server.

A person of ordinary skill in the art, having the benefit of the present disclosure, would recognize how to implement the orchestration framework shown in FIG. 5 using established programming techniques, data structures, and integration protocols. The modular configuration of the GPT Management Server and its interaction with external AI systems may be adapted across a variety of hardware and software environments without requiring undue experimentation.

While the foregoing description has set forth various embodiments and examples in connection with the accompanying drawings, it will be understood that these are provided for purposes of illustration and explanation only, and are not intended to limit the scope of the systems and methods as defined by the appended claims. Variations, modifications, and alternative arrangements will be apparent to persons of ordinary skill in the art in light of the present disclosure and may be made without departing from the spirit or scope of the claimed system and methods. Accordingly, the systems, methods, and apparatuses described herein should be understood as illustrative only, and not limiting. The scope of protection is defined solely by the appended claims, which encompass all equivalents of the subject matter described and claimed herein.

### LIST OF REFERENCE NUMERALS

### FIG. 1—Flow Diagram of Orchestration Process

10—Launch of GPT Management Server by the user, initiating a session through a client application or secure web interface.
12—Selection of subscribed or available AI System providers (Selected GPT Providers).
14—Processing mode selection, including serial, parallel, hub-and-spoke, or other orchestration strategies.
16—Prompt revision process to adapt the user's Initial AI Prompt to the input requirements of each Selected GPT Provider.
18—Submission of the Initial AI Prompt (as revised, if necessary) to each Selected GPT Provider.
20—Evaluation of Initial AI Responses returned by the Selected GPT Providers.
22—Consensus and divergence analysis among the Initial AI Responses; construction of the First Improved AI Prompt.
24—Resubmission of the First Improved AI Prompt to the Selected GPT Providers.
26—Evaluation of First Improved AI Responses returned by the Selected GPT Providers.
28—Creation of Second (or Subsequent) Improved Ai Prompts for Additional Iterative refinement.
30—Resubmission of improved prompts to the Selected GPT Providers.
32—Evaluation of responses to improved prompts; continued consensus/divergence analysis.
34—Determination that a sufficient degree of consensus and contention analysis has been achieved, representing a final consolidated response.
36—Presentation of the comprehensive Final AI Response to the user.

### FIG. 2—Final Response Presentation

38—Generation of the Final AI Response by the GPT Management Server after iterative orchestration.
40—User menu for selecting output format, level of detail, and presentation style.
42—Option for the user to view consensus and contention points, ranked statistically.
44—Option to include source associations and citations, presented as references, footnotes, endnotes, or links.
46—Formatting and organization of the Final AI Response in accordance with user preferences.
48—Display of the formatted Final AI Response to the user.

### FIG. 3—Example Hardware Configuration

50—User device (e.g., computer, tablet, smartphone, or other electronic device) with application installed.
52—Application with graphical user interface (GUI) for user prompt entry, to be transmitted to the GPT Management Server.
54—Application GUI displaying responses and outputs received back from the GPT Management Server.
56—GPT Management Server responsible for receiving prompts from the user device (#50) and coordinating orchestration of GPT providers, then returning data back to the device.
58—Example external GPT target (AI System provider 1).
60—Example external GPT target (AI System provider 2).
62—Example external GPT target (AI System provider “ . . . N”)

### FIG. 4—Example User Interface for Selection and Orchestration

64—User device interface for GPT management, supporting input and output of prompts and responses.
66—GPT Management Server including input and output operations (#68, #70).
68—User prompt receiver; receives prompt input from the user.
70—GPT engine responsible for correlating and processing prompt requests.
72—Status updater for providing the user with progress updates from the GPT engine (#70).
74—Expanded view of GPT Management Server (#66).
76—GPT selection verification processing circuit or software program, confirming chosen providers.
78—Processing circuit or software program for preparing and iterating prompts to the selected GPT providers.
80—GPT thread management process, managing individual sessions with providers.
82—Prompt response and correlation process.
84—Consensus and contention storage engine for responses.
86—Contention resolution process interacting with data stored at #84.
88—Status updater presenting consensus and contention updates to the user.

### FIG. 5—Detailed GPT Management Server Architecture

90—User prompt input (from #64/#50).
92—Detailed GPT Management Server.
94—Queue for user prompt.
96—Availability list of user-selected GPTs.
98—User input confirming GPTs to be used
100—GPT Manager verifying selections and account configuration.
102—Parallelization process for distributing prompts.
104—Prompt and GPT source selection from #94 and #100.
106—User updates and interrupt handling (via #134), communicating commands to #104.
108—Consensus and contention evaluation engine, maintaining separate queues and updating processing results.
110—GPT 1 prompt/response queue, maintaining history of exchanges.
112—GPT 2 prompt/response queue, maintaining history of exchanges.
114—GPT Nth prompt/response queue, maintaining history of exchanges.
116—Response sorting and correlation process across GPTs.
118—Contention retrieval process generating clarification prompts for resubmission.
120—Consensus storage, including sources referenced by GPT responses (e.g., books, websites, publications).
122—GPT 1 engine for communication with external GPT 1, including error handling.
124—GPT 2 engine for communication with external GPT 2, including error handling.
126—GPT Nth engine for communication with external GPT N, including error handling.
128—External GPT corresponding to GPT 1.
130—External GPT corresponding to GPT 2.
132—External GPT corresponding to GPT N.
134—User interface providing updates and data from the GPT Management Server.

What is claimed is:

1. An artificial intelligence processing system comprising a GPT Management Server configured to:
receive a First GPT Prompt from a user;
transmit, via the internet, the First GPT Prompt to a plurality of external GPT Providers, each comprising an AI System maintained externally from the GPT Management Server;
receive, via the internet, a plurality of First AI Responses generated by the respective AI Systems in response to the First GPT Prompt;
analyze the First AI Responses to identify Substantive Areas of Agreement and Substantive Areas of Disagreement among them;
generate an Improved GPT Prompt based at least in part on the Substantive Areas of Disagreement;
transmit, via the internet, the Improved GPT Prompt to at least a subset of the GPT Providers;
receive one or more Improved AI Responses; and
generate and present a Final AI Response that includes content selected from among the Substantive Areas of Agreement, the Improved AI Responses, or both.

2. The artificial intelligence processing system of claim 1, wherein the GPT Management Server is further configured to include, in the Final AI Response, content selected from among the Substantive Areas of Agreement identified from the First AI Responses or the Improved AI Responses.

3. The artificial intelligence processing system of claim 1, wherein the GPT Management Server is further configured to select a GPT Provider Search Method selected from among a hub-and-spoke architecture, serial processing, or parallel processing for transmitting at least one of the First GPT Prompt or the Improved GPT Prompt to the GPT Providers.

4. The artificial intelligence processing apparatus of claim 1, wherein the GPT Management Server is further configured to determine a Termination Condition for ceasing iterative improvement based on at least one of:
a number of iterations performed,
a detected level of agreement among AI Responses,
an absence of further Substantive Areas of Disagreement, or
a user-defined setting.

5. The artificial intelligence processing apparatus of claim 1, wherein the GPT Management Server is further configured to:
process the First GPT Prompt and any Improved GPT Prompt by transmitting them via the internet to a plurality of external AI Systems that are maintained by their respective GPT Providers; and
generate the Final AI Response based on responses received via the internet from the external AI Systems without the GPT Management Server training, maintaining, or programming the external AI Systems.

6. The artificial intelligence processing apparatus of claim 1, wherein the GPT Management Server is further configured to select or substitute one or more GPT Providers for processing an Improved GPT Prompt, based on analysis of Substantive Areas of Agreement or Substantive Areas of Disagreement identified in responses to a previous prompt.

7. The artificial intelligence processing apparatus of claim 1, wherein the GPT Management Server is further configured to adapt to changes in available GPT Providers or their underlying AI Systems, including substitution of updated or newly available models, without requiring modification to the processing logic of the GPT Management Server.

8. The artificial intelligence processing apparatus of claim 1, wherein the GPT Management Server is further configured to store and manage one or more credentials associated with the respective GPT Providers, and to securely communicate the First GPT Prompt or any Improved GPT Prompt to the corresponding external AI Systems using the credentials.

9. The artificial intelligence processing apparatus of claim 1, wherein the GPT Management Server is further configured to present the Final AI Response in an Output Format selected from a plurality of available formats, each structured to communicate Substantive Areas of Agreement and Substantive Areas of Disagreement among the responses received from the GPT Providers.

10. The artificial intelligence processing apparatus of claim 1, wherein the GPT Management Server is further configured to provide a user interface that enables user interaction with the processing of prompts and responses, including at least one of: viewing progress or status of the comparison among responses from the GPT Providers, reinitiating processing with a revised First GPT Prompt or new prompt, or selecting a different Output Format for presentation of the Final AI Response.

11. The artificial intelligence processing apparatus of claim 1, wherein the GPT Management Server is further configured to include, in the Final AI Response, supporting source information comprising either links or identifying references consulted by at least one of the GPT Providers in generating an AI Response.

12. A non-transitory computer-readable storage medium storing instructions that, when executed by a processor of a GPT Management Server, cause the processor to:
receive a First GPT Prompt from a user;
transmit, via the internet, the First GPT Prompt to a plurality of external GPT Providers, each comprising an AI System maintained externally from the GPT Management Server;
receive, via the internet, a plurality of First AI Responses generated by the respective AI Systems in response to the First GPT Prompt;
analyze the First AI Responses to identify Substantive Areas of Agreement and Substantive Areas of Disagreement among them;
generate an Improved GPT Prompt based at least in part on the Substantive Areas of Disagreement;
transmit, via the internet, the Improved GPT Prompt to at least a subset of the GPT Providers;
receive, via the internet, one or more Improved AI Responses; and
generate and present a Final AI Response that includes content selected from among the Substantive Areas of Agreement, the Improved AI Responses, or both.

13. The non-transitory computer-readable storage medium of claim 12, wherein the instructions further cause the processor to include, in the Final AI Response, content selected from among the Substantive Areas of Agreement identified from the First AI Responses or the Improved AI Responses.

14. The non-transitory computer-readable storage medium of claim 12, wherein the instructions further cause the processor to select a GPT Provider Search Method selected from among a hub-and-spoke architecture, serial processing, or parallel processing for transmitting at least one of the First GPT Prompt or the Improved GPT Prompt to the GPT Providers.

15. The non-transitory computer-readable storage medium of claim 12, wherein the instructions further cause the processor to determine a Termination Condition for ceasing iterative improvement based on at least one of:
a number of iterations performed,
a detected level of agreement among AI Responses,
an absence of further Substantive Areas of Disagreement, or
a user-defined setting.

16. The non-transitory computer-readable storage medium of claim 12, wherein the instructions further cause the processor to:
process the First GPT Prompt and any Improved GPT Prompt by transmitting them to a plurality of external AI Systems that are maintained by their respective GPT Providers; and
generate the Final AI Response based on responses received from the external AI Systems without the GPT Management Server training, maintaining, or programming the external AI Systems.

17. The non-transitory computer-readable storage medium of claim 12, wherein the instructions further cause the processor to select or substitute one or more GPT Providers for processing an Improved GPT Prompt, based on analysis of Substantive Areas of Agreement or Substantive Areas of Disagreement identified in responses to a previous prompt.

18. The non-transitory computer-readable storage medium of claim 12, wherein the instructions further cause the processor to adapt to changes in available GPT Providers or their underlying AI Systems, including substitution of updated or newly available models, without requiring modification to the processing logic of the GPT Management Server.

19. The non-transitory computer-readable storage medium of claim 12, wherein the instructions further cause the processor to store and manage one or more credentials associated with the respective GPT Providers, and to securely communicate the First GPT Prompt or any Improved GPT Prompt to the corresponding external AI Systems using the credentials.

20. The non-transitory computer-readable storage medium of claim 12, wherein the instructions further cause the processor to present the Final AI Response in an Output Format selected from a plurality of available formats, each structured to communicate Substantive Areas of Agreement and Substantive Areas of Disagreement among the responses received from the GPT Providers.

21. The non-transitory computer-readable storage medium of claim 12, wherein the instructions further cause the processor to provide a user interface that enables user interaction with the processing of prompts and responses, including at least one of:
viewing progress or status of the comparison among responses from the GPT Providers,
reinitiating processing with a revised First GPT Prompt or new prompt, or
selecting a different Output Format for presentation of the Final AI Response.

22. The non-transitory computer-readable storage medium of claim 12, wherein the instructions further cause the processor to include, in the Final AI Response, supporting source information comprising either links or identifying references consulted by at least one of the GPT Providers in generating an AI Response.
